(19) United States
(12) Patent Application Publication
(10) Pub. No.: US 2011/0247661 A1
(43) Pub. Date: Oct. 13, 2011

(54) METHOD FOR CLEANING OBJECT AND SYSTEM FOR CLEANING OBJECT

(75) Inventors: Atsushi Hayashida, Kanagawa (JP); Masao Watanabe, Fukuoka (JP); Toshiyuki Sanada, Fukuoka (JP); Minori Shirota, Fukuoka (JP)

(73) Assignees: NATIONAL UNIVERSITY CORPORATION KYUSHU UNIVERSITY, Fukuoka-shi, Fukuoka (JP); AQUA SCIENCE CORPORATION, Yokohama-shi, Kanagawa (JP)

(21) Appl. No.: 13/139,616

(22) PCT Filed: Nov. 19, 2009
(86) PCT No.: PCT/JP2009/069645

§ 371 Date: Jun. 14, 2011

(30) Foreign Application Priority Data
Dec. 15, 2008 (JP) 2008-318464

(51) Int. Cl. B08B 3/00

(52) U.S. Cl. 134/34; 134/198

(57) ABSTRACT

A system for cleaning an object and a method for cleaning an object by irradiating a multiphase fluid containing a gas and liquid droplets, wherein a desired impact force is obtained by controlling the degree of liquid-drop-impact cavitation, which is generated when the liquid droplets in the multiphase fluid hit the object.

### TECHNICAL FIELD

The present invention relates to methods and systems for treating semiconductor substrates, glass substrates, lenses, disk parts, precision-machined members, molded resin members, and the like (in particular, semiconductor substrates having aluminum materials such as aluminum interconnects on their surfaces) as objects at their predetermined portions or surfaces (for example, methods and systems for cleaning objects). More specifically, it relates to methods and systems for cleaning portions or surfaces, eliminating and removing unwanted matters attached thereto, polishing and treating surfaces of objects and the like (for example, methods for treatment in semiconductor manufacturing apparatuses, printed is substrate cleaning apparatuses, photomask cleaning apparatuses and the like, such as resist removing apparatuses, polymer removing apparatuses and cleaning apparatuses).

### BACKGROUND ART

During a pretreatment step for semiconductors, cleaning is repeated as many as 50 to 100 times on a single wafer. Objects to be cleaned off are organic matters, particles and the like, such as resist films, polymers and the like, which may affect device reliability. During the cleaning step, combinations of alkaline and acidic cleaning fluids and/or other chemicals such as sulfuric acid/hydrogen peroxide mixture are typically used and during the rinsing step for removing residues therefrom, a large amount of pure water is used. Also, while plasma aching apparatuses are generally used for removing resists, other apparatuses are used for cleaning residues and/or impurities thereafter. Also, for removing polymer films, many of amine-based organic solvents are used. Such chemical liquids may also be used for removing resists. Here, the chemical liquids used for cleaning and/or thin film removal according to the prior art described above suffer from such disadvantages that 1) they are costly; 2) they impose such a huge environmental burden that special effluent treatment facilities may be needed; 3) apparatuses will be enlarged in order to secure safety and health for operators and a huge amount of pure water will be necessary for washing chemical liquids in cleaning with the use of such; and 4) a single apparatus may not cover all the way from thin film removal to cleaning.

Also, as far as cleaning steps without the use of chemical liquids are concerned, major techniques described below exist. First, ultrasonic cleaning apparatuses are currently of the most widely used cleaning technique and may sometimes be used in combination not only with pure water but also with various cleaning fluids. They have a disadvantage that due to cavitation (having a different mechanism of action from the cavitation according to the present invention, as subsequently described) damage may be done to soft materials, fragile materials and/or micropatterns. Therefore, while countermeasures are taken to increase frequencies, or the like, there has arisen a tradeoff with detergency. Next, waterjet cleaning apparatuses are applied to relatively large objects to be cleaned. They have a disadvantage that high pressures (several MPa to 20 MPa) are needed, and they are therefore unsuitable for objects having micropatterns. Next, brush scrub cleaners may also be used in combination not only with pure water but also with various cleaning fluids. They have a disentangle that they are unsuitable for objects having deep grooves and/or pits. In addition, since the surfaces of objects may directly contact with brushes, dust and scratches may be produced.

There are also cleaning apparatuses which inject steam only. These apparatuses also have very little burden on the environment from the viewpoint that they do not use chemical liquids. The apparatuses have, however, such disadvantages that 1) they have little effect on objects such as photoresists and foreign matters on wafers that are relatively strongly attached because they do not use chemical liquids; and 2) optimum conditions depending on objects may not be adjusted because the pressure of steam generators is the only parameter.

As such, cleaning apparatuses that inject steam and fine liquid particles in combination have recently been proposed (Patent Reference 1). In this technique, first, vaporized water (steam gas) infiltrates into resist films, reaches the interface between the resist films and object surfaces, weakens the bond strength of the resist films at the interface and lifts the resist films off the object surfaces (lift off). Next, atomized water (water mist) containing fine water liquid particles at a predetermined injection pressure acts physically on the lifted-off resist films to remove them from the interface. In Paragraph 0019 of Patent Reference 1, cavitation with the use of heat effect phenomenon as the basic principle of the technique is described. Specifically, when pure water at ordinary temperature and steam at an elevated temperature are mixed, oscillation with some frequency (10 KHz to 1 MHz) occurs due to the heat exchange between them. In turn, due to this oscillation, the water molecules are decomposed into hydrogen ions and hydroxide ions and the high energy produced when these unstable ions return to water molecules may be converted into a mechanical impact. Such is the mechanism of action.

Patent Reference 1: WO2006/018948

### DISCLOSURE OF THE INVENTION

### Problems to be Solved by the Invention

When the cleaning apparatus as taught in Patent Reference 1 which injects steam and water in combination is used, however, problems may often arise that, firstly, because it utilizes a phenomenon, that is, infiltration of water molecules, which requires a certain amount of time for reaction and a realtime phenomenon in which atomized mist directly collides against resist films and/or particles to remove the films and/or stains, the treatment time will be limited by the time for the water molecules to infiltrate and that, secondly, it may often happen that detergency is insufficient to sufficiently remove stains on objects or, conversely, detergency is so strong that objects may be damaged. In such cases, countermeasures have been taken that the blowout pressure is increased in the former case and decreased in the latter case. Thus, in actuality, fluid dynamic actions (impact force or the like) have only been utilized to make adjustment to detergency. In this case, however, as the blowout pressure is increased, the steam temperature is increased to such an extent that objects low in heat resistance may not be subjected to treatment and/or the collision force is so great that damages may be done to objects in the former case. On the other hand, in the latter case, a problem may arise that cleaning of objects may be insufficient because of the low blowout pressure, although damages to the objects may be avoided. As such, a first object of the present invention is to provide a means for reliably cleaning objects without being limited by the time for water molecules to infiltrate and without doing any damage to the objects.

Further, the present inventors have empirically found that when semiconductor substrates are cleaned with a multiphase stream of water and steam, aluminum formed on the surfaces of the semiconductor substrates prematurely corrode. Thus, if aluminum corrodes before the next treatment is carried out, they may not function as semiconductor devices, leading to a situation where the yield may decrease. As such, a second object of the present invention is to provide a means for preventing aluminum formed on the surfaces of semiconductor substrates from corroding for an extended period of time.

### Means for Solving the Problems

Focusing on cavitation that is completely different in mechanism of action from the conventional cavitation mentioned above, the present inventors found that treatment suitable for objects can effectively and easily be carried out by controlling the degree of such cavitation on the objects, to have accomplished the present invention.

Further, focusing on the velocity of droplets contained in a multiphase fluid, not on the pressure of a gas, in order to increase detergency, the present inventors devotedly carried out repeated studies for increasing the velocity. Then, the inventors found that when a certain type of nozzle is used for increasing droplet velocity, matters to be removed that are attached to objects can be removed with sufficient collision force, to have accomplished the present invention.

The present (1) is a method for cleaning an object, comprising a step of injecting through a nozzle a multiphase fluid, containing steam in a continuous phase and water droplets in a dispersed phase, which is produced by mixing steam and water at a mixing portion, wherein

the mixing portion is disposed at the upstream side of the nozzle and has a water inlet portion through part of its inner wall surface;

the nozzle is an ultrahigh-velocity nozzle;

the inner wall surface of the mixing portion and an inner wall surface of the nozzle form an approximately continuous, curved surface; and

the steam flowing within the mixing portion is mixed with the water from the inner wall surface of the mixing portion so that the water is passed from the inner wall surface of the mixing portion along the inner wall surface of the nozzle to inject the multiphase fluid through an outlet of the nozzle.

The present invention (2) is the method according to the invention (1) wherein the nozzle has a divergent configuration in which the nozzle is reduced in diameter gradually from the upstream side of the nozzle to the outlet of the nozzle and is also increased in diameter across a throat portion where it has a minimum cross-sectional area.

The present invention (3) is the method according to the invention (1) or (2) wherein the mixing portion is cylindrical.

The present invention (4) is the method according to any one of the inventions (1) to (3) wherein the velocity of the droplets is in the range of 100 to 600 m/s.

The present invention (5) is the method according to any one of the inventions (1) to (4) wherein the temperature of the multiphase fluid upon reaching the object is 50° C. or higher and the pH of the multiphase fluid upon reaching the object is in the range of 7 to 9.

The present invention (6) is the method according to the invention (5) wherein the distance between a blowout outlet of the multiphase fluid and the object is 30 mm to or less.

The present invention (7) is the method according to any one of the inventions (1) to (6) wherein the object is a semiconductor substrate having an aluminum material such as aluminum interconnects on the surface.

The present invention (8) is a system for cleaning an object by injecting through a nozzle a multiphase fluid, containing steam and water droplets, comprising a steam supply means for supplying steam [for example, steam supply portion (A)], water supply means for supplying liquid water [for example, pure water supply portion (B)] and a nozzle for injecting a mixed-multiphase fluid, wherein

the mixing portion (for example, mixing portion 144) is disposed at the upstream side of the nozzle and has a water inlet portion (for example, 144a) through part of its inner wall surface, through which the flowing steam may be mixed with the water from the inner wall surface;

the nozzle is an ultrahigh-velocity nozzle (for example, nozzle 141); and

the inner wall surface of the mixing portion and an inner wall surface of the nozzle form an approximately continuous, curved surface.

The present invention (9) is the system according to the invention (8) wherein the nozzle has a divergent configuration in which the nozzle is reduced in diameter gradually from the upstream side of the nozzle to the outlet of the nozzle and is also increased in diameter across a throat portion where it has a minimum cross-sectional area.

The present invention (10) is the system according to the invention (8) or (9) wherein the mixing portion is cylindrical.

Now, the definition of each term used in DESCRIPTION will be described. First, a “water droplet” is a concept encompassing not only a water droplet derived from water but also a fine water droplet derived from wet saturated steam. A “ multiphase fluid” is a fluid having multiple, such as two or three, fluid components, examples of which may include 1) saturated steam and pure water droplets at or below the boiling point; 2) heated steam and pure water droplets at or below the boiling point; and 3) 1) or 2) in combination with an inert gas or clean high-pressure air. In case of applications in which oxidization and/or chemical reactions of objects are of no concern, however, oxygen gas and/or other inert gases may be used. Also, from the viewpoint of corrosion prevention for aluminum, it is preferred to use a two-phase fluid only of water and steam or such in combination with an inert gas. An “object” is not particularly limited, examples of which may include an electronic part, semiconductor substrate, glass substrate, lens, disk member, precision-machined member and molded resin part. “Treatment” is not particularly limited as long as it is carried out on an object, examples of which may include removal, cleaning and processing. “Water” refers to water with properties such that it may be used as pure water or ultrapure water in applications, such as for cleaning steps of semiconductor device manufacture, where contamination with fine foreign matters, metal ions and the like on objects is of concern and also encompasses lower-grade tap water in applications where contamination with fine foreign matters, metal ions and the like on objects is of no concern. A “system” refers not only to an “apparatus” which integrally houses components but also such where components are disposed at physically separated locations (for example, a plant) and such where components are not connected in an information-transmissible manner, as long as it is in its entirety equipped with components having functions defined in CLAIMS. An “ultrahigh-velocity nozzle” means a nozzle capable of accelerating droplets to the sonic velocity or higher.

Now, cavitation upon collision of droplets according to the present invention will be described in detail with reference to the drawings, in order to clarify the difference from the cavitation with other mechanisms of action which is known in the art for treating objects. The mechanisms of action described here are merely based on prediction. Therefore, the present invention is not limited in any way by such mechanisms of action.

First, the general concept of cavitation is described below.

While boiling of a liquid usually begins when the temperature of the liquid is higher than the saturation temperature at its pressure, boiling of a liquid also begins when the pressure of the liquid is lower than the saturation pressure at its temperature. In other words, steam bubbles are produced in the liquid. Thus, such bubbles that are produced by boiling due to the effect of pressure reduction instead of a change in temperature are usually called cavitation. The shrinkage and collapse of the bubbles produces a high pressure to produce erosion, noises and the like. Such a phenomenon may also be called cavitation.

In ultrasonic cleaning apparatuses conventionally used for cleaning, cavitation occurs due to the mechanisms of action as described below (FIG. 24).

1. Acoustic waves propagate through a medium due to an ultrasonic generator.

2. The acoustic waves proceed through the medium, repeating compression and decompression at dynamic cycles.

3. During the course of transition from compression to decompression, the pressure is locally reduced to the saturated steam pressure or lower.

4. Then, bubbles start growing (boiling at ordinary temperature).

5. Also, uncondensing gases in the grown steam bubbles dissolved in the medium are included.

6. The bubbles grow further.

7. The bubbles are subjected to the next compression force to be adiabatically compressed to assume high energy.

8. The bubbles are finally crushed to collapse.

9. When the bubbles are crushed, they locally produce extremely large impact energy to dissociate surrounding fouling.

10. Usually standing waves are produced by the waves traveling through the medium and the waves reflected off of the liquid surface.

11. In this case, cavitation is produced in the medium in stripes along the maximum sound pressure body.

Next, a possible mechanism for production of cavitation upon collision of droplets according to the present invention will be described with reference to a formerly reported case (Martin Rein, “Drop-Surface Interactions (Cism International Centre for Mechanical Sciences Courses and Lectures)” pp. 39-102, Martin Eein ed., Springer-Verlag, 2002).

1. When a droplet collides against a solid interface at a velocity, the kinetic energy of the droplet is converted to pressure energy to produce a high pressure at the surface of contact between the droplet and the solid interface (FIG. 25).

2. The pressure produced propagates as pressure waves (compression waves) upward in the interior of the droplet to reach the interface between the droplet and the surrounding gas, namely the free interface (FIG. 26).

3. Since the acoustic impedance of water is far greater than the acoustic impedance of the surrounding gas, impedance mismatch occurs and the pressure waves are reflected at approximately 100%. In other words, the propagation of the pressure waves to the surrounding gas is very small, with a result that the change in pressure on the free interface is held down (FIG. 27).

4. The change in pressure on the free interface is small because expansion waves that cancel compression waves, namely pressure waves that are lower in pressure than the surround is produced to propagate into the interior of the liquid.

5. The expansion waves that propagated into the interior of the droplet lower the pressure within the droplet. Boiling starts at a temperature of the droplet of approximately 30° C. when the pressure is lowered to approximately 0.04 atm, at a temperature of the droplet of approximately 60° C. when the pressure is lowered to approximately 0.2 atm and at a temperature of the droplet of approximately 80° C. when the pressure is lowered to approximately 0.5 atm, to produce and grow bubbles (FIGS. 28 and 29).

6. The steam bubbles produced grows further in size, incorporating noncondensing gases in the liquid.

7. The fully grown bubbles reach the growth limit, to start rebounding, namely shrinking. Since the shrinkage process occurs rapidly in comparison with the expansion process, the bubbles vigorously shrink so that the pressure within the bubbles can reach a pressure that is extremely higher than that at the beginning of growth. This high pressure is called a bubble collapse pressure.

8. The bubble collapse is also induced by disturbance of bubble surrounding conditions. And, the bubbles do not necessarily collapse singly. Rather, they collapse as groups of agglomerated bubbles. It has been reported that the bubble collapse pressure in such cases is approximately several hundreds or more times greater than that when bubbles collapse singly.

9. The bubble collapse pressure produced in the interior of the droplet propagates as pressure waves (compression waves) in the interior of the droplet, to reach the interface between the droplet and the solid surface and produce a very large pressure on the solid surface. This is the collapse pressure of cavitation produced upon collision of droplets, which is utilized for cleaning.

What is essentially important for the present invention is that the thermal environment surrounding the droplets is kept at a sufficiently elevated temperature by steam or that the leakage of heat from the droplets is prevented. In order that to be achieved, conditions where bubbles can sufficiently be produced even if the pressure drop by the expansion waves in the interior of the droplets are not vigorous are established. Because of such characteristics, a velocity that can produce certain compression waves, without droplets having a vigorous velocity to collide against a solid surface as in other inventions, may be sufficient.

It is the most specific respect of the present invention that cavitation is produced by droplets having a velocity produced at a pressure about two orders of magnitude lower in comparison with that of other inventions.

### Effects of the Invention

According to the present invention, in contrast to conventional methods in which impact force to an object is controlled through adjustment of blowout pressures (fluid dynamic action), cavitation upon collision of droplets produced by the droplets colliding against the surface of an object is utilized to treat the object. Such effects that conventional problems attributable to the level of blowout pressures, specifically, the concern that excessive collision force may do damage to the object and/or the problem that although damage to the object can be avoided by virtue of low blowout pressures, the object may not be sufficiently cleaned, can be solved, are therefore provided. Further, since the temperature of the droplets at the time of collision is largely related to such cavitation upon collision of droplets, the extent of the cavitation (whether it is produced or not and/or, if produced, the extent of production) can be easily controlled by changing the temperature of the droplets. In addition, since an object can be efficiently treated even under a low blowout pressure by increasing the droplet temperature, problems attributable to high blowout pressures can be avoided. Further, in case the gas is steam, a decrease in temperature of the whole system can be avoided even when heat transfer from the steam to another medium occurs, because the latent heat of the steam is utilized.

More specific actions and effects of the present inventions are as follows. (1) Cracks and/or pores on films are produced, which induce removal of the films through high-velocity side jets produced after droplet collision and/or shock waves due to bubble collapse as well as impact force of chain reactions by the shock waves (cavitation). (2) Jets and/or shock waves due to droplets, chain reactions due to the shock waves as well as high-velocity side jets are produced to flip films for removal, starting at the cracks and/or pores as described in (1). (3) Object materials are fragilized by steam, that is, water having large thermal energy and/or stress is produced to weaken the adhesion at the interface between objects and substrates. (4) Objects to be cleaned and/or objects to be removed can be broadened by changing the combination of these functions according to the objects. (5) The present invention can be applied not only to eliminate impurities but also to remove unwanted photoresists after etching and/or ion implantation steps and/or remove unwanted polymers after etching steps.

Also, according to the inventions (1) to (4) and (8) to (10), the use of an ultrahigh-velocity nozzle makes the velocity of water droplets high. Therefore, droplets are finely divided to reduce the diameter of the droplets. Accordingly, droplets having larger diameters that may cause cracking of wafers and/or disruption of patterns are hardly produced, so that such problems may be less likely to arise even at an elevated pressure.

Further, it has been observed that when an ultrahigh-velocity nozzle is used, a multiphase fluid injecting steam and water droplets and a multiphase fluid of air and water droplets exhibit two distinct behaviors described below.

First, it was clear that, by injecting a multiphase fluid of steam and water using an ultrahigh-velocity nozzle, something like pressure waves were observed near the outlet within the nozzle (Example 30). Thereby, the droplets are further finely segmentalized within the nozzle to reduce the droplet diameter, and therefore, such an effect that problems such as cracking of wafers and/or disruption of surface patterns may not arise even at an elevated pressure is provided.

Second, the relationship between a gas pressure and a droplet velocity and/or average particle diameter should be mentioned. As the gas pressure is elevated, the droplet velocity increases for a multiphase fluid of air and water, while the droplet velocity is measurable to a certain pressure, but is unmeasurable after exceeding the certain pressure for a multiphase fluid of steam and water (Example 28). Also, as the relationship between the gas pressure and the average particle diameter of water droplets is observed, it was found that the particle diameter of a multiphase fluid of air and water does not depend on the gas pressure, while data of the average particle diameter for a mixed-multiphase fluid of steam and water are unreliable when it exceeds a certain pressure (Example 29). This means that there are regions of pressures where pressures are measurable for a multiphase fluid of air and water but are unmeasurable for a multiphase fluid of steam and water. In other words, it means that the multiphase fluid of steam and water exhibits at least some behaviors different from those of the mixed-multiphase fluid of air and water. Although the differences in behaviors are not clarified, such that droplet velocity is too high or droplet diameter is too small may be conceivable as the factors that make measurement impossible.

Steam is mixed with water from the wall surface of the mixing portion upstream a nozzle to form a water film over the wall surface, which is blown out through the outlet of the nozzle to blow out a multiphase fluid of water droplets and steam. The droplets blown out collide against the surface of an object to thereby produce low-pressure portions locally within the droplets according to the mechanism of action mentioned above, enabling to produce cavitation on the surface of the object.

Also, since the nozzle to be used for injection has a divergent configuration in which the nozzle is reduced in diameter gradually from the upstream side of the nozzle to the outlet of the nozzle and is also increased in diameter across a throat portion where it has a minimum cross-sectional area, a water film is formed over the inner wall of the nozzle by the water mixed in the mixing portion and the steam is blown out through the central portion of the nozzle. Further, the water is accelerated as if it was dragged by the accelerated steam.

Further, according to the invention (5), such an effect is provided that aluminum formed on the surface of a semiconductor substrate is prevented from corroding for a long period of time, even when the semiconductor substrate is cleaned by a multiphase stream of water and steam, in addition to the sufficient impact provided by cavitation. For example, after dry etching aluminum, if a resist on the object is removed according to the method according to the invention (5) such an effect is observed that aluminum interconnects may not corrode for the time period until the next step.

According to the invention (6), because of the short distance between a blowout outlet of a multiphase fluid and an object, the multiphase fluid is less likely to absorb carbon dioxide in the atmosphere and the pH is less inclined to be acidic. Therefore, such an effect is provided that corrosion prevention effect for aluminum may better be exerted.

### BEST MODE FOR CARRYING OUT THE INVENTION

The present invention will be described specifically with reference by way of example to a “wafer cleaning apparatus” as an apparatus for cleaning objects as the best mode. The best mode is merely the best illustration and shall not be regarded as limiting the technical scope of the present invention.

Composition of Multiphase Fluid

First, a multiphase fluid according to the best mode includes steam in a continuous phase and water droplets in a dispersed phase, produced by mixing steam and water. Here, a “water droplet” consists of pure water suitable for treating objects made of materials that disfavor chemicals (in addition, part of steam high in wetness). Besides, the-multiphase fluid may optionally contain argon, an inert gas such as nitrogen, and the like, and/or clean, high-pressure air. From the viewpoint of corrosion prevention for aluminum, however, the optional gas may preferably be argon or an inert gas.

Here, steam is used because it has the advantage that, in addition to having high specific heat, latent heat can be used so that the temperature may hardly drop even under conditions where the droplets may be deprived of calorie in accordance with the change in pressure of the fluid. When droplets and a gas are mixed in a fluid mixing portion, heat transfer occurs between the droplets and the gas and/or heat transfer occurs between the droplets and the inner walls of the mixing portion and/or the pipings. Besides, the temperature of the gas drops because expansion under reduced pressure occurs when the gas is accelerated in the nozzle portion to be emitted to the atmosphere. On this occasion, whether the temperature of the droplets drops or not is determined by the latent heat of the gas. When pure water is mixed with a gas not containing much latent heat, such as an inert gas and/or clean, high-pressure air, the temperature of the gas drops so that temperature control may be difficult. On the other hand, when the gas is steam, since it has a certain amount of latent heat, the temperature of the gas is less likely to drop due to heat transfer whenever the gas is mixed with droplets at a relatively low temperature or the heat is drawn to the inner walls of the piping so that temperature control may tend to be easier. If the latent heat of steam is insufficient, however, droplets may be produced as part of the steam is liquefied, which have an influence on shock waves produced on the surface of an object to be treated. Besides, when this multiphase fluid is finally accelerated at the throat of the nozzle, although the temperature of the fluid drops in order to obtain the kinetic energy of the fluid, the drop in temperature of the fluid may be reduced by virtue of the latent heat of the steam.

Overall Architecture of Apparatus for Treating Objects

FIG. 1 is an overall view of an apparatus 100 for treating objects according to an embodiment of the present invention. The apparatus 100 includes a steam supply section (A), a pure water supply section (B), a steam fluid regulating section (C), a mixed-multiphase fluid injecting section (D) and a mechanical section for holding, rotating and elevating/lowering a wafer (E). Each section will be described in detail below.

(A) Steam Supply Section

The steam supply section (A) is composed of a water supply pipe 111 for supplying pure water, a steam generator 112 for heating the water to a predetermined temperature D1 (° C.) or higher to produce steam and controlling the amount of the produced steam to pressurize the steam to a predetermined pressure C1 (MP), a switchable steam on/off valve 113 responsible for supply and cutoff of the steam, a pressure gauge 114 for measuring the pressure of the steam supplied downstream from the steam generator 112, a steam pressure regulating valve 115 for regulating the steam supply pressure to a predetermined value, a heated steam generator/saturated steam wetness regulator with temperature control mechanism 116 for regulating the amount of fine droplets within the supplied steam, and a pressure release valve 117 as a safety device.

(B) Pure Water Supply Section

The pure water supply section (B) is composed of a water supply pipe 121 for supplying pure water, a heating portion with pure water temperature control mechanism 122 for providing the pure water with thermal energy, a pure water on/off valve 123 responsible for cutoff and resumption of supply of the pure water, a pure water flowmeter 124 for monitoring the flow rate of the pure water, and a pure water on/off valve for producing two fluids 125 responsible for cutoff and resumption of supply of the pure water downstream in case of two fluids.

(C) Steam Fluid Regulating Section

The steam fluid regulating section (C) includes a heating portion with steam fluid temperature control mechanism 131 for regulating the temperature of steam fluid and/or the wetness of saturated steam.

(D) Multiphase Fluid Injecting Section

The multiphase fluid injecting section (D) is composed of an injection nozzle 141 movable along longitudinal and lateral directions (the X axis nozzle scan range or the Y axis nozzle scan range in FIG. 1) for injecting a multiphase fluid against an object, a flexible piping 142 for providing smooth nozzle movement, a pressure gauge 143 for measuring the pressure of the multiphase fluid immediately before the nozzle, a gas-liquid mixing portion 144 for introducing pure water into a steam piping so that it forms a water film over the wall surface, and an orifice 145 for pure water to be smoothly introduced into a gas piping. Here, the nozzle 141 is an ultrahigh-velocity nozzle. An “ultrahigh-velocity nozzle” is not particular limited as long as it is capable of accelerating droplets to the sonic velocity or higher, examples of which may include sonic nozzles. FIG. 30 is a cross-sectional view of a sonic nozzle and mixing portion according to the best mode. Although the sonic nozzle is not particularly limited in shape, it has a divergent nozzle configuration in which the interior of the nozzle is reduced in diameter abruptly from the upstream side of the nozzle located upper in the drawing to the outlet of the nozzle located lower in the drawing and is also relatively gradually increased in diameter across a location (throat portion) where it has a minimum cross-sectional area A₃ so that the fluid may not detach from the inner wall. The cross-sectional area A₃ of the throat portion is calculated by dividing the flow rate by the sonic velocity. The cross-sectional area A₃ of the throat portion is not particularly limited, but is from 3.0 to 20.0 mm², for example. Also the expansion ratio (A₃/A₂) is calculated according to the equation represented by Formula 1 below:

$$[ Mathematical formula 1 ]$$

$$\frac{\\ {A}_{3}}{{A}_{2}} - \frac{{ϕ}_{2}}{{ϕ}_{3}} = \sqrt{\frac{κ + 1}{κ - 1} {( \frac{κ + 1}{2} )}^{2 / ( κ - 1 )} {( \frac{{P}_{2}}{{P}_{1}} )}^{2 / κ} \{ 1 - {( \frac{{P}_{2}}{{P}_{1}} )}^{( κ - 1 ) / κ} \}} - {( \frac{κ + 1}{2} )}^{1 / ( κ - 1 )} {( \frac{{P}_{2}}{{P}_{1}} )}^{1 / κ} \sqrt{\frac{κ + 1}{κ - 1} \{ 1 - {( \frac{{P}_{2}}{{P}_{1}} )}^{( κ 1 ) 1 / κ} \}}$$

Here, κ is the ratio of specific heat of a gas (specific heat at constant pressure/specific heat capacity at constant volume), P₁ is the pressure at the throat portion of the nozzle, P₂ is the pressure at the nozzle outlet. On the basis of the expansion ratio and the cross-sectional area A₃ of the throat portion, the cross-sectional area A₂ at the nozzle outlet may be given. Here, the cross-sectional area A₂ at the nozzle outlet is not particularly limited, but is from 7.0 to 28.0 mm², for example. Also, the length of the nozzle can be adjusted to an appropriate value in consideration of various parameters such as nozzle material, roughness and flow velocity (the Reynolds number). Also, the degree of expansion can be adjusted to an appropriate value in consideration of various parameters such as viscosity, density and flow velocity. The shape of the nozzle outlet is not particularly limited, but may be circular. Also, the inner wall surface of the mixing portion and the inner wall surface of the nozzle form an approximately continuous, curved surface. The mixing portion may be joined as a cylindrical body upstream within the nozzle or may be formed upstream within the nozzle. When the wall surface of the mixing portion and the wall surface of the nozzle are joined, it is preferred that the joint is formed so that the liquid passed from the mixing portion along the wall surface, forming a water film, may flow also along the wall surface of the nozzle, forming a water film. Although not limited, while the piping may include seams, it is preferred that they are smoothly integrated to such a degree that they may not thereby represent such obstacles that may not exfoliate the liquid off the liquid surface. The mixing portion 144 will subsequently be described in detail.

(E) Mechanical Section for Holding, Rotating and Elevating/Lowering Wafer

The mechanical section for holding, rotating and elevating/lowering a wafer (E) is composed of a stage 151 capable of carrying and holding objects (wafers), a rotating motor 152 for rotating the stage 151, a mechanism for elevating/lowering wafers 153 capable of regulating the distance between the outlet of the nozzle 141 and the wafer by moving the stage 151 along the vertical direction, a cooling water pipe 154 for supplying cooling water for cooling the objects (wafers), a switchable cooling water on/off valve 155 for cutting off and resuming the supply of the cooling water, a cooling water flow rate regulating valve 156 for regulating the flow rate of the cooling water and a cooling water flowmeter 157 for measuring the flow rate of the cooling water.

Now that the overall architecture of the apparatus for treating objects according to the best mode has been described in general, the mixing portion 144 in the multiphase fluid injection section (D) will be described in detail below. The mixing portion 144 has a water inlet portion 144a through part of its inner wall surface at the upstream side of the nozzle, through which water from the wall surface of the mixing portion can be mixed with the steam at an angle of 90 degree or less in relation to the direction of travel of the steam (FIG. 30). The mixing portion may preferably be cylindrical and the inner diameter of the cross section to be joined with the nozzle of the mixing portion may preferably be identical with the inner diameter of the inlet of the nozzle.

Here, FIG. 2 is a drawing illustrating a detailed architecture of the mixing portion 144 provided as a multiphase fluid gas/liquid mixing portion with temperature control mechanism. In the mixing portion 144, it is important to minimize the generation of phase change phenomena such as liquefaction of steam and gasification of water along the inner wall of the mixing portion. To that end, as illustrated in FIG. 2, it is preferred that architecture as described below is adopted.

1) The direction of each fluid of gas and liquid has an angle lower than 90 degree in the mixing portion in order to stabilize mixing.

2) The piping diameter of the liquid fluid or the orifice fitted to the piping is sufficiently small in comparison with the cross-sectional area of the channel of the gas fluid in the mixing portion.

3) By incorporating a heater, the temperature of the inner wall of the mixing portion is regulated so that it may comply with the following conditions. The temperature of the inner wall is not largely different from the saturation temperature of the liquid under the pressure within the mixing portion (within ±20%). Also, the temperature of the inner wall is not largely different from the saturation temperature of the gas under the pressure within the mixing portion (within ±20%). Since, with the passage of time, the inner wall of the mixing portion approaches the saturation temperature of the fluid, the heating function by the heater may be omitted under the condition where the temperature of the mixing portion is sufficiently kept, for applications where the time period for the conditions of the multiphase stream to stabilize is of no concern.

In an apparatus in which objects are treated by a multiphase fluid made of mixed droplets and a gas, when the apparatus is activated, the fluid mixing portion is at ordinary temperature. When there is a difference in temperature between the portion and the steam, nonuniformity in temperature arises within the liquid mixing apparatus. Thereby, the discharge pressure of the multiphase fluid is instabilized due to the phase change of part of the steam into droplets or the like, and it is difficult to stably apply constant shock waves on the surface of an object to be treated, therefore taking more time for the apparatus to stably operate. In other words, when a heater is installed in the multiphase fluid regulating portion, the fluid mixing portion may be set at the same temperature of the steam from the beginning of activation, so that the gas-liquid phase change within the mixing portion may be less likely to occur, enabling the apparatus to apply stable shock waves to the surface to be treated.

Principle for Cavitation Control (Bubble Collapse-Related Parameters)

The cleaning apparatus according to the best mode has the functions of controlling the temperature of droplets, the flow velocity of droplets, the size of droplets, the number of droplets, the surface temperature of an object to be cleaned and the area to be injected with a multiphase fluid per unit time, by regulating the gas pressure, the flow rate of water mixed in the multiphase fluid, the gas temperature, the temperature of water to be mixed, the nozzle shape, the distance from the nozzle outlet to the object, the temperature of the object and the relative time for travel between the nozzle and the object. Among these bubble collapse-related parameters, the flow velocity of droplets, the temperature and the droplet density are particularly important. By controlling these parameters, jets by droplets, shock waves by bubble collapse and impact force of chain reactions by the shock waves can be obtained on the surface of the object to be treated, so that effective treatment can be carried out in cleaning and the like. The flow velocity contributes to the generation of shock waves by the collapse of bubbles within the droplets upon collision of the droplets, while the temperature contributes to the production of bubbles within the droplets. The higher the droplet density is, the higher the probability that shock waves are generated is. For example, when the number of droplets is zero, no shock waves are generated by the collision of droplets. When the number of droplets is too dense, however, a decrease in velocity and/or temperature of the multiphase fluid may occur to decrease the probability of generation of shock waves. Here, a droplet density refers to the total number of droplets in a mixed-multiphase fluid per unit volume/unit time. Since measuring instruments have not yet been developed for precisely measuring fine droplets on the order of microns traveling at high velocity, the amount of pure water introduced into the multiphase fluid is used instead.

Means for Measuring Cavitation

The system according to the present invention is equipped with a means for measuring to what extent cavitation has been produced under given conditions after injecting a multiphase stream against an object or sample for measurement under the conditions. Here, according to the state of the art, it is impossible to carry out removal and cleaning processes while monitoring the size (magnitude) and density (number produced per unit volume and time) of cavitation (shock waves). Therefore, the present system adopts a procedure in which parameters involved in the production of cavitation are varied in preliminary experiments to carry out process treatment and then the magnitude of cavitation is determined on the basis of the resulting data as follows.

(1) A means for measuring physical changes for quantitatively determining o physical changes of objects or samples for measurement.

Irregularity of a metal surface when a multiphase fluid is injected against the metal surface.

Area of resist removed and lack of residue when injection is carried out against a resist surface.

Removal rate of foreign matters attached to the wholes surface of a wafer.

(2) An acoustic means for measurement capable of sensing magnitude of cavitation noise.

Magnitude of cavitation noise as sensed by an acoustic sensor.

(3) A means for measuring visual changes for quantitatively determining visual changes of objects or samples for measurement.

Image data of resist removal processes as captured by a high-speed camera.

For example, data of the temperature of a multiphase fluid and the irregularity of a metal surface injected with the fluid are confirmed as in FIG. 9. Also, the correlation between the resist removing performance and each parameter is confirmed by a large amount of data accumulated for the last three years. One example of such is the data shown in FIG. 8. For example, when the blowout pressure of a multiphase fluid through the nozzle is increased, the resist removal area is greater and the residue gets less. When the injection pressure is excessively increased, however, physical damage may be done to the object and the advantage that is characteristic of the present invention, that is, processing at lower pressures, may be impaired. Therefore, according to the present apparatus, the maximum blowout pressure through the nozzle is determined to be 0.3 MPa. This also produces a result that no special pressure-resistant parts must be used so that inexpensive but safe apparatuses may easily be produced. When the type of nozzles and the distance between the nozzle and the object are fixed, the results are obtained as shown in FIGS. 21, 22 and 23. Since no units are available for representing the magnitude of shock waves generated by droplets colliding at high velocity as mentioned before, however, the magnitude is represented as a unitless relative value.

In the prior art (for example, Patent Reference 1) the apparatuses have configurations that are not so different from the present best mode except for the use of ultrahigh-velocity nozzles. In the prior art, however, no focus is at all placed on the physical force of “shock waves” in treating objects and, therefore, no control has been provided as to whether shock waves are produced or not on the objects. Also, under the conditions of the prior art, “cavitation” is exclusively produced in nozzles having tapered tips and the shock waves generated are extremely short-lived to disappear before reaching the objects. Specifically, a multiphase fluid flowing through a nozzle increases its flow velocity when it approaches the nozzle tip. Then, as a result of decompression caused by the increase in the flow velocity, the liquid undergoes a cavitation phenomenon to generate shock waves. According to “Cavitation” by Yoji Kato, published by Maki Shoten Publisher, the collapse duration of hydrogen bubbles within a liquid shock wave pipe is from two to three microseconds. The travel time in three microseconds of a fluid at a flow velocity of 400 msec is only 1.2 mm and the bubble collapse phenomenon disappears between the nozzle throat and the nozzle outlet. Even if bubble collapse occurs at the nozzle outlet, it will be structurally difficult to set the object distance at 1.2 mm or less. According to the present invention, on the other hand, the principal function of a nozzle is to accelerate a multiphase fluid or to enlarge an area of injection. Also, cavitation collapse-related parameters related to the generation of cavitation may basically be regulated anywhere, for example, at a fluid mixing portion at any location along the fluid piping before the nozzle, as long as a focus is placed on cavitation on objects. Specifically, the control may be provided anywhere within the range of the arrows indicated by α in FIG. 1 (between the steam generator and the nozzle outlet). Principal cavitation collapse-related parameters will subsequently be described in detail.

Corrosion Prevention for Aluminum

The method for cleaning objects according to the best mode provides a corrosion prevention effect for aluminum along with the impact force described above. Again, the corrosion prevention effect can be controlled by regulating the gas pressure, the temperature of water to be mixed, the nozzle shape, the distance from the nozzle outlet to the object, the temperature of the object and the relative time for travel between the nozzle and the object. Among these related parameters, the temperature of the multiphase fluid upon reaching the object and the pH of the multiphase fluid upon reaching the object are particularly important. By controlling these parameters, it is possible to form a special protective film over the surface of aluminum which provides a corrosion prevention effect. Parameters relating to corrosion prevention for aluminum will be described in detail below, along with principal bubble collapse-related parameters.

(I) Temperature of Fluid

The-shock waves are supposed to be mainly generated by cavitation produced by droplets upon collision against the surface of an object to be cleaned and by the collapse of the cavitation. Cavitation is a cavity produced when a low-pressure portion is created in part of a liquid such as water, and tends to be produced more when the temperatures of a gas and liquid are higher. In other words, the higher the temperature of droplets is, the easier the production of bubbles in the droplets is. Subsequently, more bubble collapse underlying shock waves with large energy occur on the surface of the object to be treated and when, for example, the method for treatment is used for removal of resist films, resist films and/or foreign objects attached relatively strongly can be eliminated. On the other hand, when the temperatures of a multiphase fluid and/or water droplets are set low, the generation of shock waves on the surface of an object to be treated is subsequently held down so that objects relatively low in strength may be cleaned. However, there is a limit in the level of temperature which can be set according to the heat resistance of the object and the like. Although it is predicted that if the distance to the object is longer when the temperature is too high, gaseous components within the droplets may escape, rendering the generation of nuclei of bubbles more difficult, the distance of the object from the nozzle outlet of 2 to 30 mm can be ignored. The temperature of steam to be supplied within the nozzle is preferably from 50 to 120° C., more preferably from 80 to 115° C., and even more preferably from 90 to 110° C. Also, the temperature of water to be mixed with the steam is preferably from 0 to 40° C., more preferably from 10 to 35° C., and even more preferably from 20 to 30° C.

Here, in particular, the temperature of the multiphase fluid upon reaching the object is preferably 50° C. or higher, more preferably 80° C. or higher, and even more preferably 90° C. or higher. The determination of the temperature of the multiphase fluid shall be carried out according to the method described in EXAMPLES. Within such ranges, a special film having a corrosion prevention effect will be formed over the aluminum on the surface of the object.

(II) Velocity of Droplets

The higher the velocity of droplets is, the greater the impact of the droplets upon colliding against the surface of an object is and the more easily created the internal pressure difference is. As a result, bubble collapse occurs and cavitation is more easily produced. In other words, if the velocity of the droplets is set high, shock waves with large energy is subsequently generated on the surface of the object to be treated, and when, for example, the method for treatment is used for removal of resist films, resist films and/or foreign objects attached relatively strongly can be eliminated. On the other hand, when the temperature of droplets is set low, the generation of shock waves on the surface of the object to be treated is subsequently held down so that objects relatively low in strength may be cleaned. Also, by increasing the velocity of the droplets, the multiphase fluid is exposed to air in a shorter period of time and, therefore, it is less likely to incorporate carbon dioxide in the atmosphere, to be less inclined to be acidic, so that corrosion resistance effects may preferably be exerted. The velocity of droplets is preferably from 100 to 600 m/s, more preferably from 200 to 500 m/s and even more preferably from 250 to 350 m/s. With the velocity of a fluid within such ranges, impact force by cavitation can be obtained. The velocity of droplets, as approximately corresponding to the velocity of a fluid, shall be defined as [flow rate]/[cross-sectional area of nozzle]. Here, the flow rate represents a steam flow rate (m³/s) and the cross-sectional area of a nozzle represents a cross-sectional area at the nozzle outlet (m²).

(III) Other Parameters

First, as the nozzle, an ultrahigh-velocity nozzle is used, as mentioned above. With the use of this nozzle, the velocity of a fluid changes, so do the magnitude of shock waves. In principle, the use of a nozzle with a high flow velocity makes it easier to obtain shock waves. Besides, by injecting a multiphase fluid containing steam and water droplets using an ultrahigh-velocity nozzle, a special behavior is observed on the basis of the relationship between the pressure of the steam and the velocity and diameter of the water droplets. The steam pressure is from 0.05 to 0.25 MPa and, under the condition of steam pressure of 0.15 MPa or higher in particular, a multiphase fluid of steam and water droplets exhibits behaviors largely different from those of a multiphase fluid of air and water droplets. Next, the distance from the nozzle outlet to an object is typically in the range of 2 to 30 mm (the optimum range of 2 to 10 mm), preferably 5 mm or less, more preferably 3 mm or less, and even more preferably 2 mm or less. Although as the distance from the nozzle outlet to a wafer is reduced, the performance for removing resists will also improve, an optimum distance exists and if they are too close, the performance for removal will degrade. Conversely, if the performance for removing and/or cleaning is desired to be reduced, the distance may only be increased from the optimum distance. Besides, the less the distance from the nozzle outlet to an object is, the less likely incorporated carbon dioxide in the atmosphere is, to be less inclined to be acidic.

In addition, if particularly high impact force is desired to be obtained, it is important that the surround is covered with steam when droplets collide against an object. Here, the flow rate of steam is, in terms of mass flow rate of steam, preferably from 0.083 to 1.0 kg/min, more preferably from 0.025 to 0.75 kg/min and even more preferably from 0.33 to 0.50 kg/min Besides, the gas-liquid mixing ratio (liquid/gas) is preferably from 0.00018 to 0.01. The droplet diameter is preferably from 2 to 25 μm. When the droplet diameter is larger, the surface area is smaller so that less carbon dioxide in the atmosphere may be incorporated, to be less inclined to be acidic. The droplet diameter will be determined using an instrument manufactured by TSI Incorporated according to PDA (Phase Doppler Anemometry) at a location 5 mm from the nozzle outlet unless otherwise specified. The fluid flow rate/blowout outlet cross-sectional area is preferably from 0.5 to 32.0 kg cm⁻²min⁻¹.

In order to allow water to form a water film over the wall surface, it is preferred that, for example, the pressure to be applied to the water in mixing the water with a multiphase fluid is adjusted to such an extent that the water may not backflow due to the pressure of the steam. The pressure to be applied to water is not particularly limited, but for example, pressures at or higher than the pressure of the introduced steam at which the water may not be injected, may be applied for introduction. More specifically, the pressure for introduction of water preferably satisfies the formula below:

(pressure of steam+0.02 MPa)<(pressure for introduction of water)<(pressure of steam+1.0 MPa)

If the pressure for introduction of water is too low, the water is introduced as pulsating flows and characteristics of the fluid are instabilized. When the pressure is too high, the water spatters up to the center in the direction of nozzle diameter, making it difficult to form a uniform water film and inhibiting the acceleration of steam. Besides, it is preferred not to pressurize in the direction of injection from the viewpoint of forming a water film on the wall surface and it is more preferred to supply from a vertical direction with respect to the direction of travel of the steam.

The pH of the multiphase fluid upon reaching an object is preferably from 7.0 to 9.0, more preferably from 7.0 to 8.0 and even more preferably from 7.0 to 7.5. By setting the pH within such ranges, a special film can be formed over aluminum on the surface of the object, which provides corrosion prevention effects for aluminum. The pH will be determined according to the method described in EXAMPLES.

### EXAMPLES

Method for Determining Temperature of Multiphase Fluid Upon Reaching Object

FIG. 31 is a schematic view of an apparatus for determining the temperature of a multiphase fluid upon reaching an object. Using a tape TA, a thermocouple TH (alumel-chromel thermocouple, JIS C1602) is affixed on a silicon wafer W 6 inches in diameter and 0.625 mm in thickness. Conditions such as the distance between the fluid injection outlet of a nozzle 141 and the object, the steam pressure and the flow rate of pure water are set identical with those when treating the object and injection is carried out against the thermocouple for one minute. The temperature when a steady state is reached is defined as the temperature of the multiphase fluid upon reaching the object.

Method for Determining pH of Multiphase Fluid Upon Reaching Object

FIG. 32 is a schematic view of an apparatus for determining the pH of a multiphase fluid upon reaching an object. The blowout outlet of a nozzle 141 is connected to a cooling tube C (for example, Graham coil type condenser) via a piping P to collect condensed water into a container R. The pH of the water was determined according to the method of JIS Z 8802. The condensing operation described above is to be carried out without contact with the air.

### Example 1

Under the conditions described below, a multiphase fluid (using steam or the air as gas) was injected against an aluminum surface for 10 minutes. AFM images taken before and after the treatment are shown in FIG. 3. Data of surface roughness are shown in FIG. 5. The surface roughness in this Example was determined according to the method for profile analysis attached to AFM.

Pressure of steam: 0.2 MPa

Temperature of steam: 130° C.

Flow rate of pure water: 300 cc/min

Temperature of pure water: 20° C.

GAP: 5 mm

Nozzle scan fixed

### Example 2

Under the same conditions as in Example 1, a multiphase fluid (using steam or the air as gas) was injected against a steel surface for 10 minutes. AFM images taken before and after the treatment are shown in FIG. 4. Data of surface roughness are shown in FIG. 6.

### Example 3

The cleaning technique using steam as taught in Patent Reference 1 removes resists using chemical reactions of steam and mechanical actions of jet and therefore requires time on the order of minutes to remove the resists. In order to investigate if the present procedure has the same mechanism of action, visualization was carried out using a high-speed video recording. Under the same conditions as in Example 1 except that the nozzle scan rate was 100 mm/sec, a mixed-multiphase fluid was injected. Chronological changes when an i-line positive resist is removed as observed from the bottom of a quartz wafer are shown in FIG. 7. As seen in the drawing, the resist was removed very quickly, gradually extending the removed region.

### Example 4

Under the same conditions as in Example 1 except that the nozzle scan rate was 40 mm/sec, a multiphase fluid was injected against a silicon wafer after being implanted with a high concentration of ions and chronological changes in removal of an i-line positive resist were observed. The results are shown in FIG. 8.

### Examples 5 to 8

Under the conditions described below, a multiphase fluid was injected against an aluminum surface for 10 minutes, while changing the gas and temperature of the multiphase fluid. AFM images taken before and after the treatment are shown in FIG. 9. Data of surface roughness are shown in FIG. 10. The surface of the aluminum surface to be treated before the treatment showed an Ra of 34.9 nm.

Pressure of gas: 0.2 MPa

Flow rate of fluid: 300 cc/min

Gap: 10 mm

As a result of injecting a multiphase fluid consisting of low-temperature air (20° C.) and low-temperature pure water droplets (20° C.) a surface having an Ra of 30.5 nm was obtained. AFM images of the surface and data of surface roughness are respectively shown in FIG. 9(a) and FIG. 10(a) (Example 5). Next, as a result of injecting a multiphase fluid consisting of high-temperature air (130° C.) and low-temperature pure water droplets (20° C.) a surface having an Ra of 96.4 nm was obtained. AFM images of the surface and data of surface roughness are respectively shown in FIG. 9(b) and FIG. 10(b) (Example 6). Next, as a result of injecting a multiphase fluid consisting of high-temperature air (130° C.) and high-temperature pure water droplets (60° C.) a surface having an Ra of 86.3 nm was obtained. AFM images of the surface and data of surface roughness are respectively shown in FIG. 9(c) and FIG. 10(c) (Example 7). While the surface roughness of (c) is slightly less than that of (b), the density of rough portions are higher than that of (b) so that more effect of shock waves may be seen in (c) than in (b). Next, as a result of injecting a multiphase fluid consisting of steam and low-temperature pure water droplets (20° C.) a surface having an Ra of 257 nm was obtained. AFM images of the surface and data of surface roughness are respectively shown in FIG. 9(d) and FIG. 10(d) (Example 8). On the basis of the results above, it was made clear that shock waves grew larger as the temperature increased and, especially when steam was used as a gas, the greatest shock waves were applied against the surface of an object to be treated.

### Examples 9 to 10

Under the same conditions as in Examples 5 to 8, injection was carried out against an Al anodic oxidization surface having an Ra of 348.8 nm, while changing the gas and temperature of the multiphase fluid. As a result of injecting a multiphase fluid consisting of air at 20° C. and pure water droplets at 20° C., a surface having an Ra of 380 nm was obtained. AFM images of the surface and data of surface roughness are respectively shown in FIG. 11(a) and FIG. 11(c) (Example 9). Next, as a result of injecting a multiphase fluid consisting of steam at 130° C. and pure water droplets at 20° C., a surface having an Ra of 440 nm was obtained. AFM images of the surface and data of surface roughness are respectively shown in FIG. 11(b) and FIG. 11(d) (Example 10).

### Examples 11

Under the same conditions as in Examples 5 to 8, injection was carried out against a stainless steel surface having an Ra of 8.1 nm, while changing the gas and temperature of the multiphase fluid. As a result of injecting a multiphase fluid consisting of steam at 130° C. and pure water droplets at 20° C., a surface having an Ra of 19.9 nm was obtained. AFM images of the surface and data of surface roughness are respectively shown in FIG. 12(a) and FIG. 12(b) (Example 11).

### Examples 12

Under the same conditions as in Examples 5 to 8, injection was carried out against a titanium surface having an Ra of 75.5 nm, while changing the gas and temperature of the multiphase fluid. As a result of injecting a multiphase fluid consisting of steam at 130° C. and pure water droplets at 20° C., a surface having an Ra of 98 nm was obtained. AFM images of the surface and data of surface roughness are respectively shown in FIG. 13(a) and FIG. 13(b) (Example 12). For titanium, interference fringes were visually observed. An oxide film may have been formed over the surface.

### Examples 13

Under the same conditions as in Examples 5 to 8, injection was carried out against a silicon surface having an Ra of 1.9 nm, while changing the gas and temperature of the multiphase fluid. As a result of injecting a multiphase fluid consisting of steam at 130° C. and pure water droplets at 20° C., a surface having an Ra of 7.6 nm was obtained. AFM images of the surface and data of surface roughness are respectively shown in FIG. 14(a) and FIG. 14(b) (Example 13).

### Examples 14 to 25

In Examples 14 to 25, a study was carried out if any difference in removal was observed or not, depending on the conditions of resist application. Under the presence or absence of HMDS, while changing the baking temperature to 90° C. and 110° C., effects of the changes in conditions were observed. Results suggesting that the surface profiles after treatment did not depend on undercoating with HMDS were obtained. The experiment was carried out under the conditions below:

Samples used: i-line resists

Time period of injection: Until when removal is visually observed

Pressure of gas: 0.2 MPa

Flow rate of liquid: 300 cc/min

Nozzle scan: Fixed

Gap: 10 mm

A resist film was applied without HMDS under the condition of baking at 90° C. and the sample was subjected to injection under the conditions described above. The interfaces of removal by the treatment observed under a microscope and through AFM are respectively shown in FIGS. 15(a) to (c) and FIGS. 15(d) to (f). FIG. 15(a) shows the surface observed under a microscope after injecting a multiphase fluid consisting of air at 20° C. and pure water at 20° C. and FIG. 15(d) is its corresponding AFM image (Example 14). FIG. 15(b) shows the surface observed under a microscope after injecting a multiphase fluid consisting of air at 130° C. and pure water at 90° C. and FIG. 15(e) is its corresponding AFM image (Example 15). FIG. 15(c) shows the surface observed under a microscope after injecting a multiphase fluid consisting of steam at 130° C. and pure water at 20° C. and FIG. 15(f) is its corresponding AFM image (Example 16).

A resist film was applied without HMDS under the condition of baking at 110° C. and the sample was subjected to injection under the conditions described above. The interfaces of removal by the treatment observed under a microscope and through AFM are respectively shown in FIGS. 16(a) to (c) and FIGS. 16(d) to (f). FIG. 16(a) shows the surface observed under a microscope after injecting a multiphase fluid consisting of air at 20° C. and pure water at 20° C. and FIG. 16(d) is its corresponding AFM image (Example 17). FIG. 16(b) shows the surface observed under a microscope after injecting a multiphase fluid consisting of air at 130° C. and pure water at 90° C. and FIG. 16(e) is its corresponding AFM image (Example 18). FIG. 16(c) shows the surface observed under a microscope after injecting a multiphase fluid consisting of steam at 130° C. and pure water at 20° C. and FIG. 16(f) is its corresponding AFM image (Example 19).

A resist film was applied with HMDS under the condition of baking at 90° C. and the sample was subjected to injection under the conditions described above. The interfaces of removal by the treatment observed under a microscope and through AFM are respectively shown in FIGS. 17(a) to (c) and FIGS. 17(d) to (f). FIG. 17(a) shows the surface observed under a microscope after injecting a multiphase fluid consisting of air at 20° C. and pure water at 20° C. and FIG. 17(d) is its corresponding AFM image (Example 20). FIG. 17(b) shows the surface observed under a microscope after injecting a multiphase fluid consisting of air at 130° C. and pure water at 90° C. and FIG. 17(e) is its corresponding AFM image (Example 21). FIG. 17(c) shows the surface observed under a microscope after injecting a multiphase fluid consisting of steam at 130° C. and pure water at 20° C. and FIG. 17(f) is its corresponding AFM image (Example 22).

A resist film was applied with HMDS under the condition of baking at 110° C. and the sample was subjected to injection under the conditions described above. The interfaces of removal by the treatment observed under a microscope and through AFM are respectively shown in FIGS. 18(a) to (c) and FIGS. 18(d) to (f). FIG. 18(a) shows the surface observed under a microscope after injecting a multiphase fluid consisting of air at 20° C. and pure water at 20° C. and FIG. 18(d) is its corresponding AFM image (Example 23). FIG. 18(b) shows the surface observed under a microscope after injecting a multiphase fluid consisting of air at 130° C. and pure water at 90° C. and FIG. 18(e) is its corresponding AFM image (Example 24). FIG. 18(c) shows the surface observed under a microscope after injecting a multiphase fluid consisting of steam at 130° C. and pure water at 20° C. and FIG. 18(f) is its corresponding AFM image (Example 25).

### Example 26

The relationship between droplet diameter and flow velocity is shown in FIG. 19. The flow velocity and diameter of droplets were determined at various flow rates of pure water while keeping the steam pressure constant (0.2 MPa). The results are shown in FIG. 19. The relationship between the droplet velocity v and the diameter d as measured through PDA is shown. Both v and d are close to the normal distribution and their averages are respectively approximately 280 m/s and approximately 10 μm.

### Example 27

The results in relation to v and d when the flow rate of pure water q equals to 100 mL/min using a steam pressure p and a distance from the nozzle h as parameters are shown in FIG. 20. For comparison, the results with mixed jets of air and droplets are shown in the dotted lines. From the drawings, it can be seen that the droplet velocities of interest are approximately from 200 to 300 m/s and the droplet diameter is approximately 10 μm.

### Example 28

### Relationship Between Gas Pressure and Droplet Velocity

A multiphase fluid of steam and water and another multiphase fluid of air and water were injected using a sonic nozzle at a flow rate of water of 200 cc/min while varying the pressure of the gas to 0.05, 0.1 and 0.2 MPa, to determine droplet velocities at locations 5 and 10 mm from the blowout outlet with an LDA (Laser Doppler Anemometry) (FIG. 33). The measurement of LDA was carried out by an LDA manufactured by TSI Incorporated. The measurement was terminated when data for 10,000 droplets were obtained and three measurements were taken under each condition. It was observed that when the multiphase fluid of steam and water was used, the velocity of droplets was higher at the location 10 mm than at the location 5 mm. Also, for the multiphase fluid of air and water, a tendency was observed that the higher the pressure of air, the higher the velocity of droplets would be. On the other hand, for the multiphase fluid of steam and water, for some unknown reasons, it was observed that, as the pressure of steam was increased, the velocity of droplets increased to a given value, but dropped at 0.2 MPa according to the measured values. This is, however, assumed to be an error. Under other conditions, a measurement required approximately less than 10 seconds, while only for the multiphase fluid of steam and water under the condition of steam pressure of 0.2 MPa, the measurement required several minutes. Therefore, it can be assumed that noises were mostly observed under the condition.

### Example 29

### Relationship Between Gas Pressure and Droplet Diameter

A multiphase fluid of steam and water and another multiphase fluid of air and water were injected using a sonic nozzle at a flow rate of water of 200 cc/min while varying the pressure of the gas to 0.05, 0.1 and 0.2 MPa, to determine the diameters of the droplets at locations 5 and 10 mm from the blowout outlet according to PDA (FIG. 34). The measurement of PDA was terminated when data for 10,000 droplets were obtained and three measurements were taken under each condition. For the multiphase fluid of air and water, the velocity of droplets varied little when the air pressure was varied. On the other hand, for the multiphase fluid of steam and water, for some unknown reasons, a phenomenon was observed that, as the pressure of steam was increased, the diameter of droplets showed little change to a given value, but rapidly decreased at 0.2 MPa. This is, however, assumed to be an error. Under other conditions, a measurement required approximately less than 10 seconds, while for the multiphase fluid of steam and water under the condition of steam pressure of 0.2 MPa, the measurement required several minutes. Therefore, it can be assumed that noises were mostly observed under the condition.

### Example 30

### Pressure Waves in Nozzle

A multiphase fluid of steam and water was injected using a quartz nozzle at a flow rate of pure water of 100 cc/min under the condition of steam pressures of 0.1 and 0.2 MPa. Then, pressure waves were observed at the tip of the quartz nozzle. The appearance is shown in FIG. 35. FIG. 35(a) shows the injection under the condition of 0.1 MPa and FIG. 35(b) shows the injection under the condition of 0.2 MPa. For comparison, a multiphase fluid of air and water was injected using a quartz nozzle at a flow rate of pure water of 100 cc/min under the condition of gas pressures of 0.1 and 0.2 MPa. No pressure waves were, however, observed at the tip of the quartz nozzle. The appearance is shown in FIG. 36. FIG. 36(a) shows the injection under the condition of 0.1 MPa and FIG. 36(b) shows the injection under the condition of 0.2 MPa.

### Examples 1 to 36

Using a cleaning apparatus having a sonic nozzle according to the best mode (FIG. 30), a multiphase fluid of steam and water was injected against an object under the conditions listed below to evaluate its cleaning effects, physical breakdown and corrosion resistance of interconnects (Tables 1 and 2). As the object, to a silicon wafer having aluminum interconnects was applied an i-line negative resist (THMRip 3300, Tokyo Ohka Kogyo Co., Ltd.) at a thickness of 1 μm, and the wafer was baked at 90° C. for 120 min, exposed at 365 nm for 20 seconds and developed at room temperature with TMAH ([N(CH₃)₄]⁺OH⁻), and the resulting silicon wafer was used.

TABLE 1

| | Treatment conditions | | | | | | | | | | | |
|---|---|---|---|---|---|---|---|---|---|---|---|---|
| | | Mixed | | | Distances | | | | | | | |
| | Fluid | water | Droplet | | between | | Liquid-gas | | | Interconnect corrosion | | |
| | temper- | temper- | veloci- | | nozzle and | Steam | mixing | Droplet | | | Immediately | |
| | atures/ | atures/ | ties/ | pH/ | object/ | pressures/ | ratios/ | diameters/ | Polymer | Physical | after | After 10 |
| | ° C. | ° C. | ms⁻¹ | — | mm | MPa | — | μm | removal | breakdown | treatment | days |
| Example 1 | 50 | 0 | 100 | 7.0 | 5 | 0. 05 | 0. 010 | 18 | Removed | Not found | Not found | Not found |
| Example 2 | 50 | 0 | 100 | 9.0 | 5 | 0. 05 | 0. 010 | 18 | Removed | Not found | Not found | Not found |
| Example 3 | 50 | 0 | 300 | 7.0 | 5 | 0. 20 | 0. 010 | 9 | Removed | Not found | Not found | Not found |
| Example 4 | 50 | 0 | 300 | 9.0 | 5 | 0. 20 | 0. 010 | 9 | Removed | Not found | Not found | Not found |
| Example 5 | 50 | 0 | 600 | 7.0 | 5 | 0. 23 | 0. 010 | — | Removed | Not found | Not found | Not found |
| Example 6 | 50 | 0 | 600 | 9.0 | 5 | 0. 23 | 0. 010 | — | Removed | Not found | Not found | Not found |
| Example 7 | 50 | 40 | 100 | 7.0 | 5 | 0. 05 | 0. 010 | 18 | Removed | Not found | Not found | Not found |
| Example 8 | 50 | 40 | 100 | 9.0 | 5 | 0. 05 | 0. 010 | 18 | Removed | Not found | Not found | Not found |
| Example 9 | 50 | 40 | 300 | 7.0 | 5 | 0. 20 | 0. 010 | 9 | Removed | Not found | Not found | Not found |
| Example 10 | 50 | 40 | 300 | 9.0 | 5 | 0. 20 | 0. 010 | 9 | Removed | Not found | Not found | Not found |
| Example 11 | 50 | 40 | 600 | 7.0 | 5 | 0. 23 | 0. 010 | — | Removed | Not found | Not found | Not found |
| Example 12 | 50 | 40 | 600 | 9.0 | 5 | 0. 23 | 0. 010 | — | Removed | Not found | Not found | Not found |
| Example 13 | 105 | 0 | 100 | 7.0 | 5 | 0. 05 | 0. 010 | 18 | Removed | Not found | Not found | Not found |
| Example 14 | 105 | 0 | 100 | 9.0 | 5 | 0. 05 | 0. 010 | 18 | Removed | Not found | Not found | Not found |
| Example 15 | 105 | 0 | 300 | 7.0 | 5 | 0. 20 | 0. 010 | 9 | Removed | Not found | Not found | Not found |
| Example 16 | 105 | 0 | 300 | 9.0 | 5 | 0. 20 | 0. 010 | 9 | Removed | Not found | Not found | Not found |
| Example 17 | 105 | 0 | 600 | 7.0 | 5 | 0. 23 | 0. 010 | — | Removed | Not found | Not found | Not found |
| Example 18 | 105 | 0 | 600 | 9.0 | 5 | 0. 23 | 0. 010 | — | Removed | Not found | Not found | Not found |
| Example 19 | 105 | 40 | 100 | 7.0 | 5 | 0. 05 | 0. 010 | 18 | Removed | Not found | Not found | Not found |
| Example 20 | 105 | 40 | 100 | 9.0 | 5 | 0. 05 | 0. 010 | 18 | Removed | Not found | Not found | Not found |

TABLE 2

| | Treatment conditions | | | | | | | | | | | |
|---|---|---|---|---|---|---|---|---|---|---|---|---|
| | | Mixed | | | Distances | | | | | | | |
| | Fluid | water | Droplet | | between | | Liquid-gas | | | Interconnect corrosion | | |
| | temper- | temper- | veloci- | | nozzle and | Steam | mixing | Droplet | | | Immediately | |
| | atures/ | atures/ | ties/ | pH/ | object/ | pressures/ | ratios/ | diameters/ | Polymer | Physical | after | After 10 |
| | ° C. | ° C. | ms⁻¹ | — | mm | MPa | — | μm | removal | breakdown | treatment | days |
| Example 21 | 105 | 40 | 300 | 7.0 | 5 | 0.20 | 0. 010 | 9 | Removed | Not found | Not found | Not found |
| Example 22 | 105 | 40 | 300 | 9.0 | 5 | 0.20 | 0. 010 | 9 | Removed | Not found | Not found | Not found |
| Example 23 | 105 | 40 | 600 | 7.0 | 5 | 0.23 | 0. 010 | — | Removed | Not found | Not found | Not found |
| Example 24 | 105 | 40 | 600 | 9.0 | 5 | 0.23 | 0. 010 | — | Removed | Not found | Not found | Not found |
| Example 25 | 120 | 0 | 100 | 7.0 | 5 | 0.05 | 0. 010 | 18 | Removed | Not found | Not found | Not found |
| Example 26 | 120 | 0 | 100 | 9.0 | 5 | 0.05 | 0. 010 | 18 | Removed | Not found | Not found | Not found |
| Example 27 | 120 | 0 | 300 | 7.0 | 5 | 0.20 | 0. 010 | 9 | Removed | Not found | Not found | Not found |
| Example 28 | 120 | 0 | 300 | 9.0 | 5 | 0.20 | 0. 010 | 9 | Removed | Not found | Not found | Not found |
| Example 29 | 120 | 0 | 600 | 7.0 | 5 | 0.23 | 0 .010 | — | Removed | Not found | Not found | Not found |
| Example 30 | 120 | 0 | 600 | 9.0 | 5 | 0.23 | 0. 010 | — | Removed | Not found | Not found | Not found |
| Example 31 | 120 | 40 | 100 | 7.0 | 5 | 0.05 | 0. 010 | 18 | Removed | Not found | Not found | Not found |
| Example 32 | 120 | 40 | 100 | 9.0 | 5 | 0.05 | 0. 010 | 18 | Removed | Not found | Not found | Not found |
| Example 33 | 120 | 40 | 300 | 7.0 | 5 | 0.20 | 0. 010 | 9 | Removed | Not found | Not found | Not found |
| Example 34 | 120 | 40 | 300 | 9.0 | 5 | 0.20 | 0. 010 | 9 | Removed | Not found | Not found | Not found |
| Example 35 | 120 | 40 | 600 | 7.0 | 5 | 0.23 | 0. 010 | — | Removed | Not found | Not found | Not found |
| Example 36 | 120 | 40 | 600 | 9.0 | 5 | 0.23 | 0. 010 | — | Removed | Not found | Not found | Not found |

### COMPARATIVE EXAMPLES

Comparative Example 1 is for the case where a fluid temperature is too low. When the fluid temperature was too low, polymers were removed but interconnects corroded in 10 days.

Comparative Examples 2 and 3 are for the case where a droplet velocity is too low and the case where a droplet velocity is too high, respectively. When the velocity was too low, polymers remained and when the velocity was too high, physical breakdown of interconnects was observed.

Comparative Examples 4 and 5 are for the case where a pH is too low and the case where a pH is too high, respectively. When the pH was too low, no protective films were produced and corrosion of interconnects were observed in 10 days. When the pH was too high, corrosion of interconnects occurred due to the high pH.

TABLE 3

| | Treatment conditions | | | | | | | | | | | |
|---|---|---|---|---|---|---|---|---|---|---|---|---|
| | | Mixed | | | Distances | | | | | | | |
| | Fluid | water | Droplet | | between | | Liquid-gas | | | Interconnect corrosion | | |
| | temper- | temper- | veloci- | | nozzle and | Steam | mixing | Droplet | | | Immediately | |
| | atures/ | atures/ | ties/ | pH/ | object/ | pressures/ | ratios/ | diameters/ | Polymer | Physical | after | After 10 |
| | ° C. | ° C. | ms⁻¹ | — | mm | MPa | — | μm | removal | breakdown | treatment | days |
| Comparative | 45 | 20 | 300 | 8. 0 | 5 | 0. 20 | 0. 010 | 9 | Removed | Not found | Not found | Found |
| Example 1 | | | | | | | | | | | | |
| Comparative | 105 | 20 | 95 | 8. 0 | 5 | 0. 03 | 0. 010 | 18 | Remained | Not found | Not found | Not found |
| Example 2 | | | | | | | | | | | | |
| Comparative | 105 | 20 | 610 | 8. 0 | 5 | 0. 27 | 0. 010 | — | Removed | Found | Not found | — |
| Example 3 | | | | | | | | | | | | |
| Comparative | 105 | 20 | 300 | 6. 5 | 5 | 0. 20 | 0. 010 | 9 | Removed | Not found | Not found | Found |
| Example 4 | | | | | | | | | | | | |
| Comparative | 105 | 20 | 300 | 9. 5 | 5 | 0. 20 | 0. 010 | 9 | Removed | Not found | Found | — |
| Example 5 | | | | | | | | | | | | |

### INDUSTRIAL APPLICABILITY

The present invention is applicable to various processings for an extremely wide range of objects from high-strength materials to low-strength materials. For example, the prevent invention can be utilized for processings such as removal of unwanted matters, cleaning and polishing of semiconductor devices, liquid crystals, magnetic heads, disks, printed substrates, lenses for cameras and the like, precision-machined components, molded resin products and the like and/or deflashing treatment in the fields such as microstructures using silicon processing techniques, mold processing and the like. Further, the present invention is particularly suitable for treatment of materials which disfavor chemicals.

### BRIEF DESCRIPTION OF THE DRAWINGS

FIG. 1 is a view illustrating the overall configuration of a treatment apparatus according to the best mode of the present invention.

FIG. 2 is a schematic view of a gas-liquid mixing portion for multiphase fluid with temperature control mechanism according to the best mode of the present invention.

FIG. 3 is a drawing which shows AFM images of aluminum surfaces observed 10 minutes after injection of a multiphase fluid against the surfaces in Example 1.

FIG. 4 is a drawing which shows AFM images of steel surfaces observed 10 minutes after injection of a multiphase fluid against the surfaces in Example 2.

FIG. 5 is a drawing which shows surface roughness data 10 minutes after injection of a multiphase fluid against aluminum surfaces in Example 1.

FIG. 6 is a drawing which shows surface roughness data 10 minutes after injection of a multiphase fluid against steel surfaces in Example 2.

FIG. 7 is a drawing which shows the results of resist removal processes observed from the backside with a high-speed camera while injecting a multiphase fluid against a resist applied on a transparent wafer in Example 3.

FIG. 8 is a drawing which shows data of resist removal by injection of a multiphase fluid after implantation with a high concentration of ions in Example 4.

FIG. 9 is a drawing which shows the results of Examples 5 to 8.

FIG. 10 is a drawing which shows the results of Examples 5 to 8.

FIG. 11 is a drawing which shows the results of Examples 9 to 10.

FIG. 12 is a drawing which shows the results of Example 11.

FIG. 13 is a drawing which shows the results of Example 12.

FIG. 14 is a drawing which shows the results of Example 13.

FIG. 15 is a drawing which shows the results of Examples 14 to 16.

FIG. 16 is a drawing which shows the results of Examples 17 to 19.

FIG. 17 is a drawing which shows the results of Examples 20 to 22.

FIG. 18 is a drawing which shows the results of Examples 23 to 25.

FIG. 19 is a drawing which shows the results of Example 26.

FIG. 20 is a drawing which shows the results of Example 27.

FIG. 21 is a drawing which shows the change in magnitude of shock waves due to the difference in thermal energy of multiphase fluids.

FIG. 22 is a drawing which shows the change in magnitude of shock waves due to the difference in velocity of multiphase fluids.

FIG. 23 is a drawing which shows the change in magnitude of shock waves due to the difference in density of multiphase fluids.

FIG. 24 is a drawing which shows the mechanism of cavitation production by ultrasonic waves.

FIG. 25 is a drawing which shows the mechanism of cavitation produced upon collision of a droplet.

FIG. 26 is a drawing which shows the mechanism of cavitation produced upon collision of a droplet.

FIG. 27 is a drawing which shows the mechanism of cavitation produced upon collision of a droplet.

FIG. 28 is a drawing which shows the mechanism of cavitation produced upon collision of a droplet.

FIG. 29 is a drawing which shows the mechanism of cavitation produced upon collision of a droplet.

FIG. 30 is a drawing which shows a configuration of a sonic nozzle and mixing portion.

FIG. 31 is a schematic illustration which shows the apparatus for measuring the temperature of multiphase fluids.

FIG. 32 is a schematic illustration of an apparatus for determining the pH of multiphase fluids.

FIG. 33 is a drawing which shows the relationship between gas pressure and water droplet velocity.

FIG. 34 is a drawing which shows the relationship between gas pressure and water droplet diameter.

FIG. 35 is a drawing which shows pressure waves generated within a quartz nozzle.

FIG. 35 is a drawing which shows the state where pressure waves are not produced within the quartz nozzle.

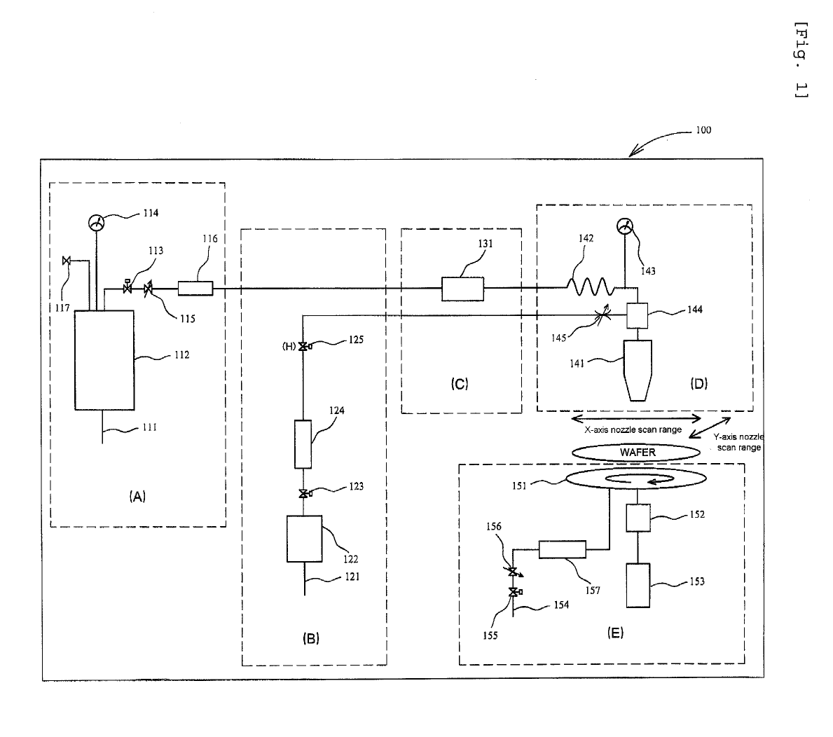

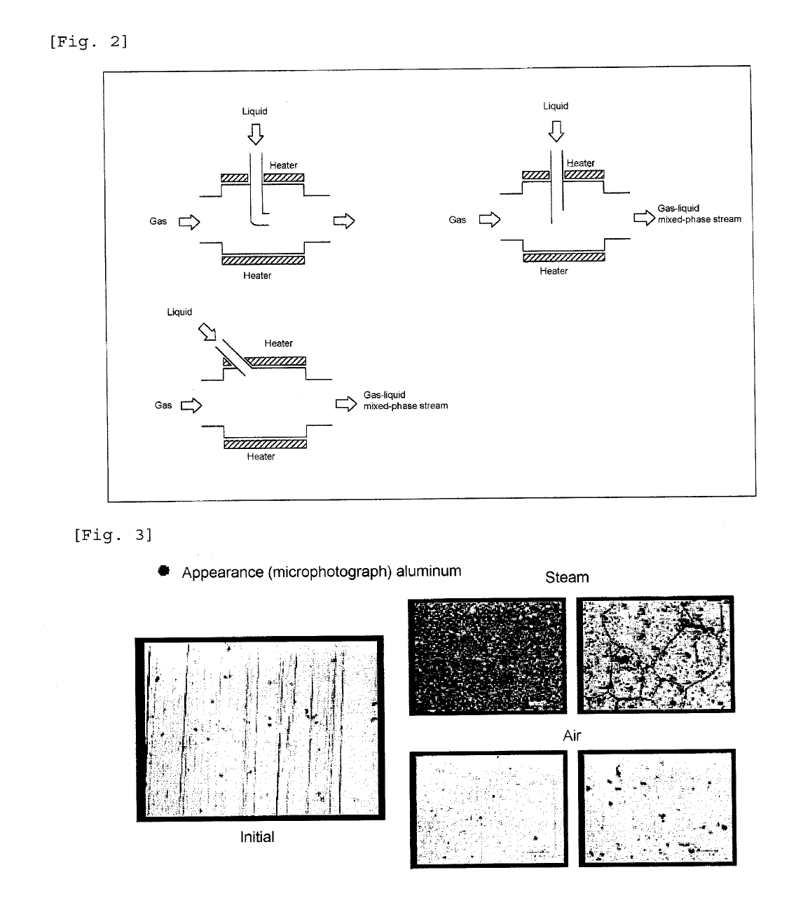

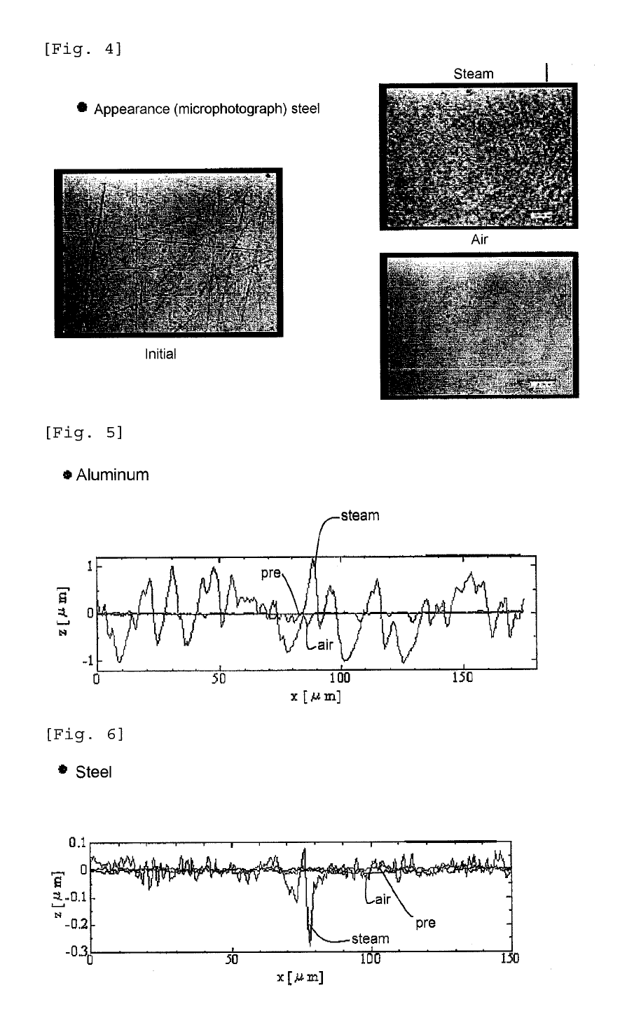

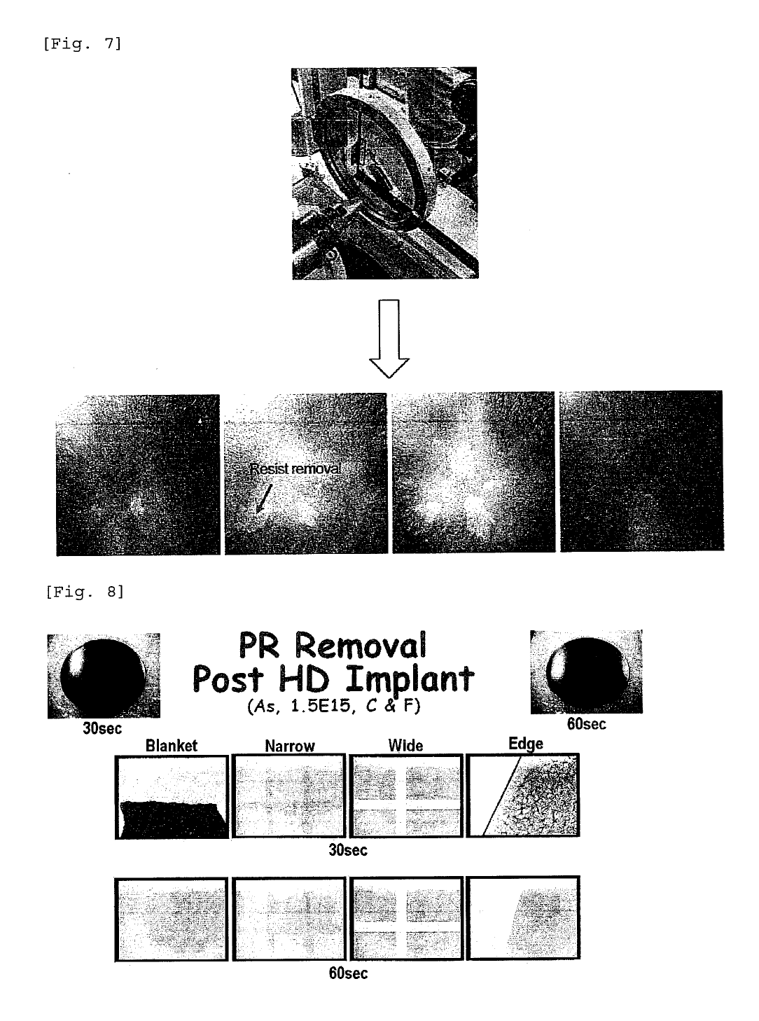

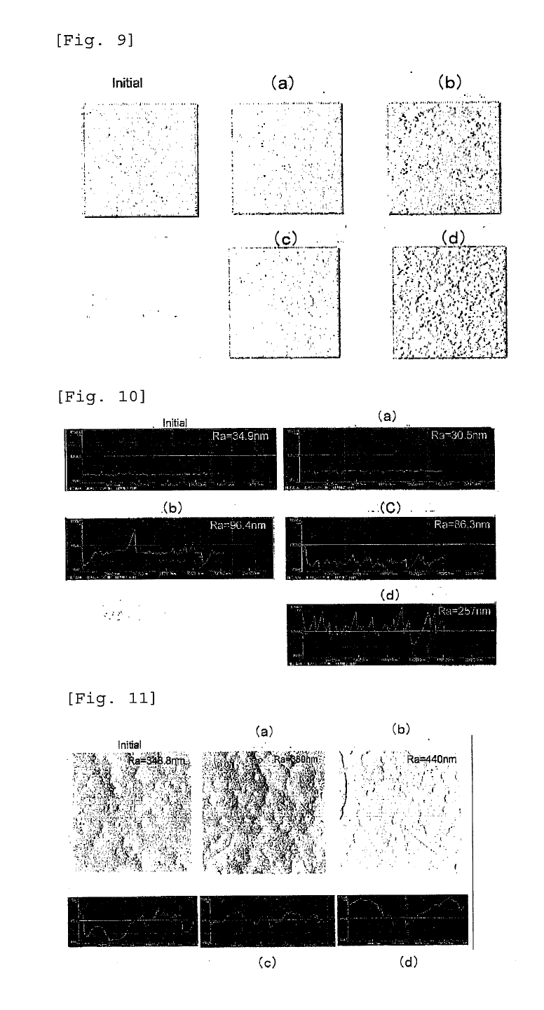

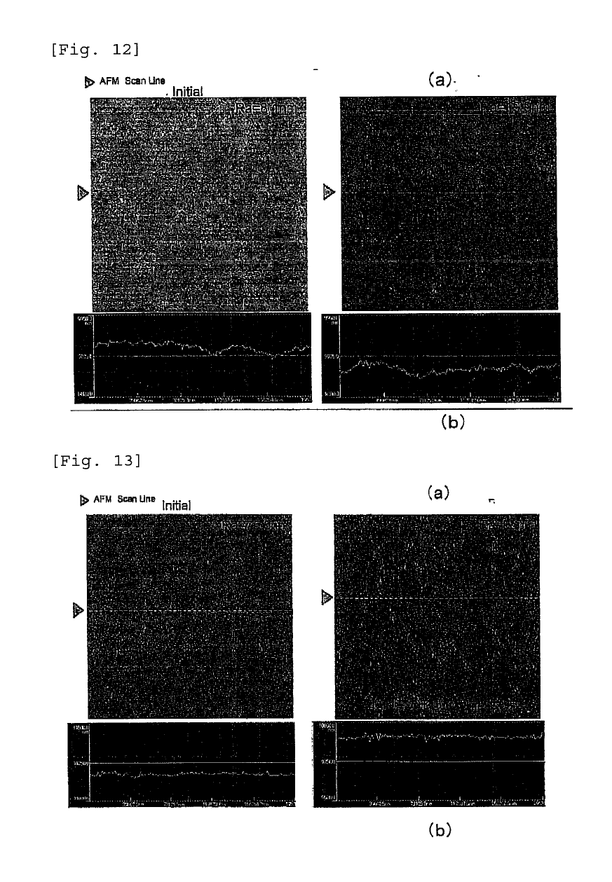

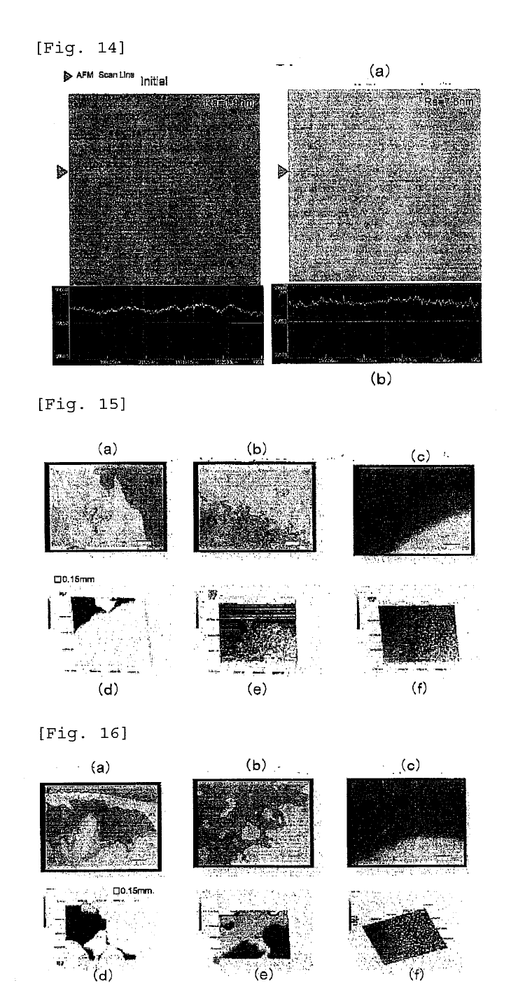

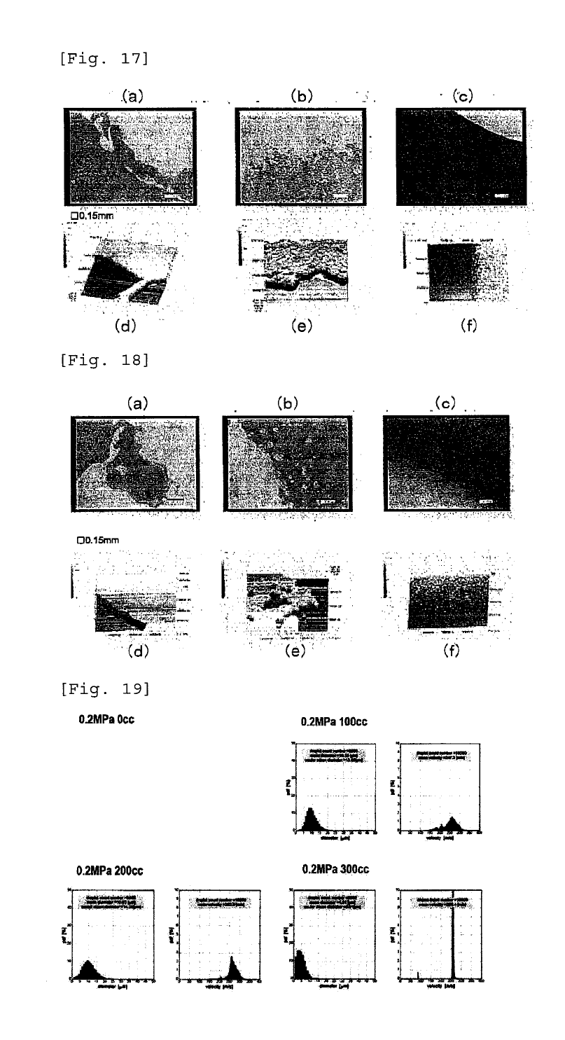

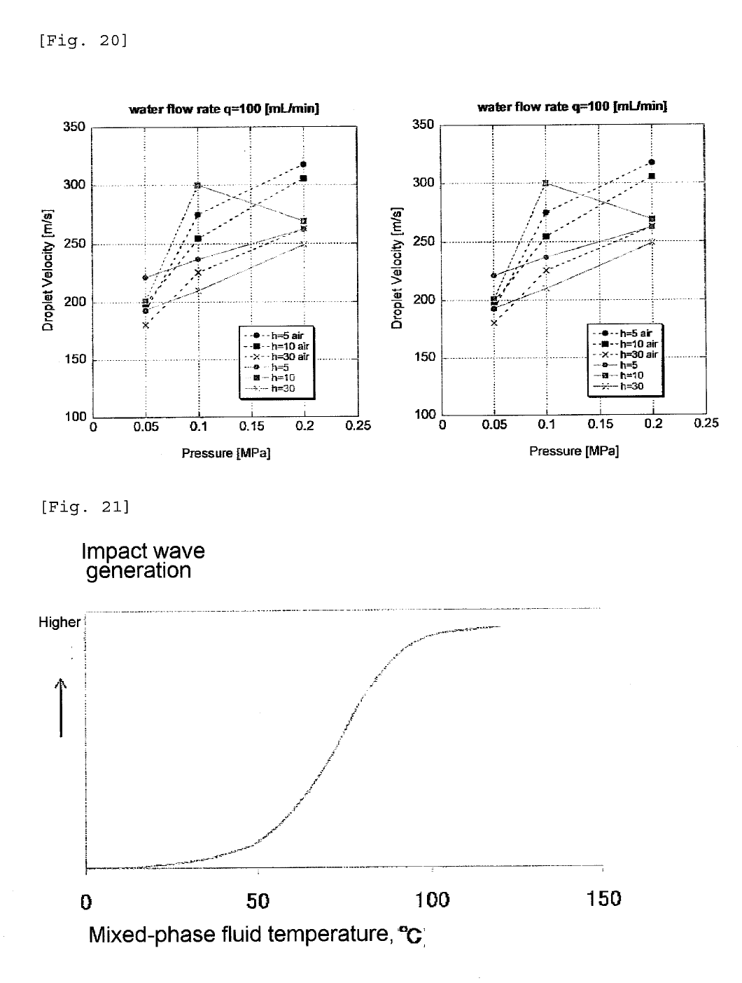

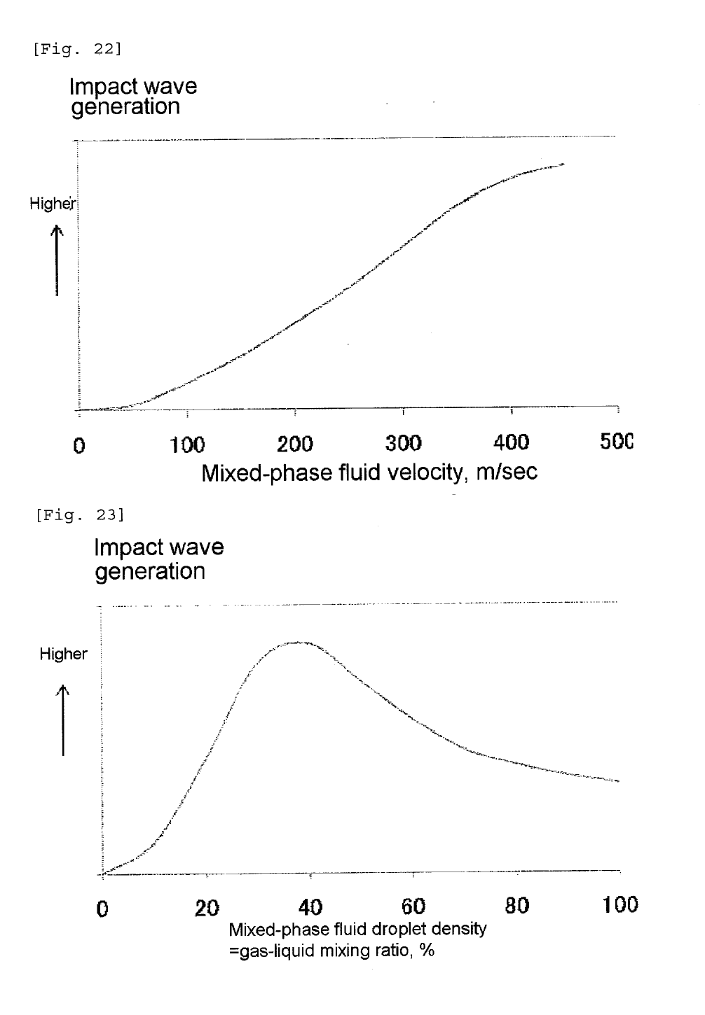

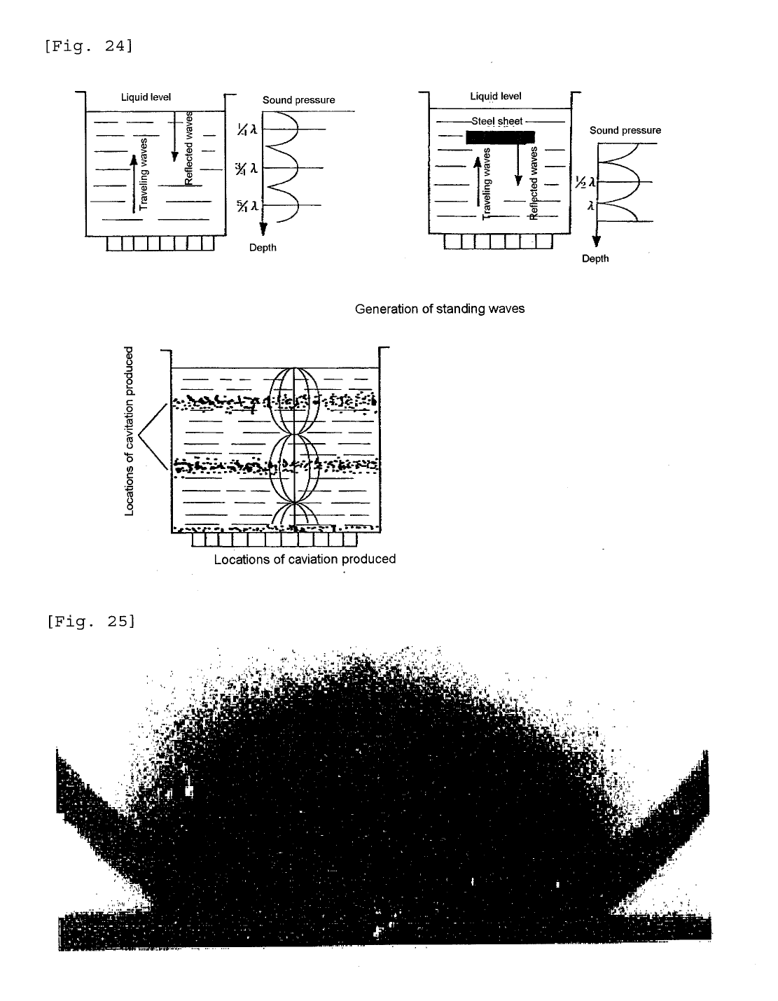

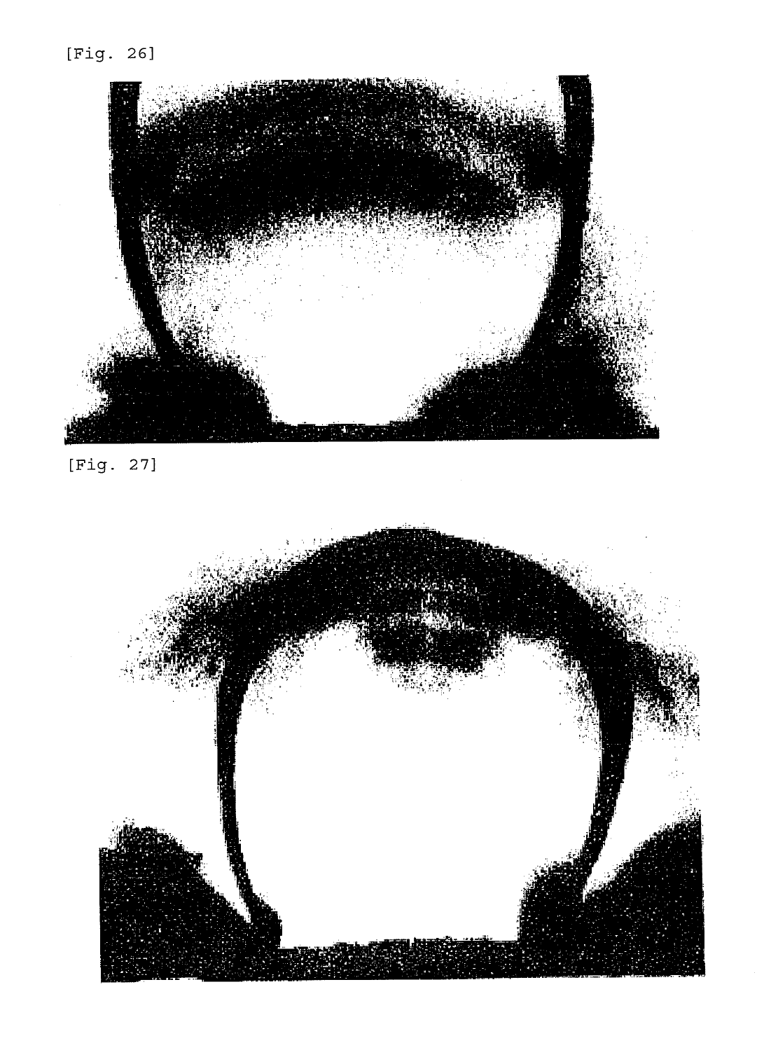

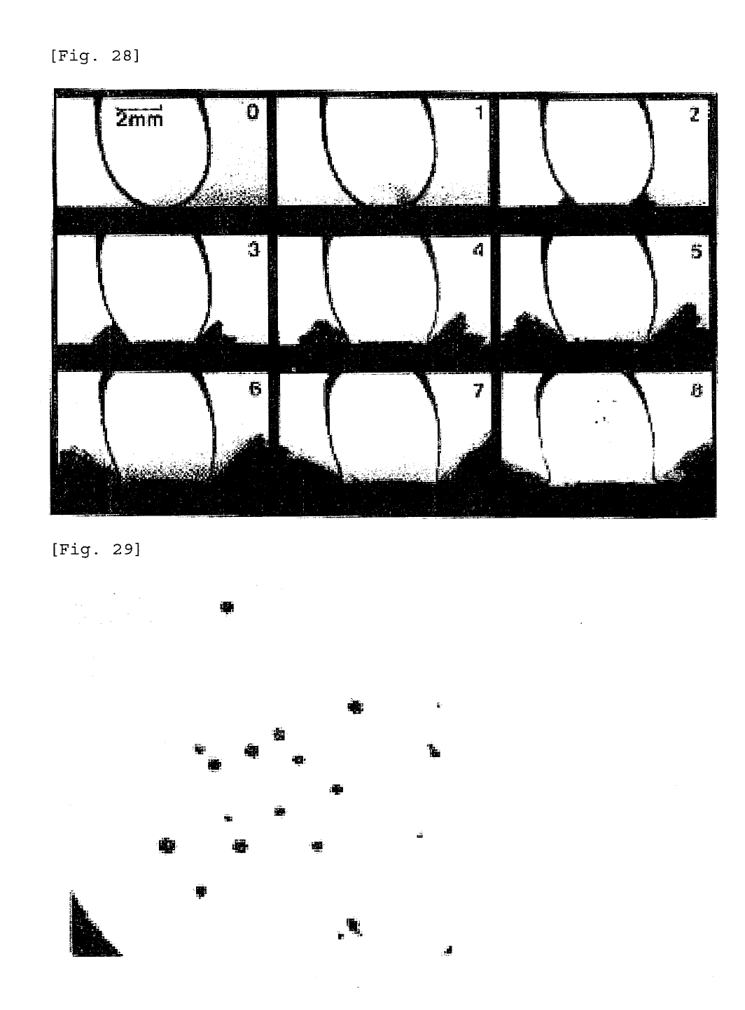

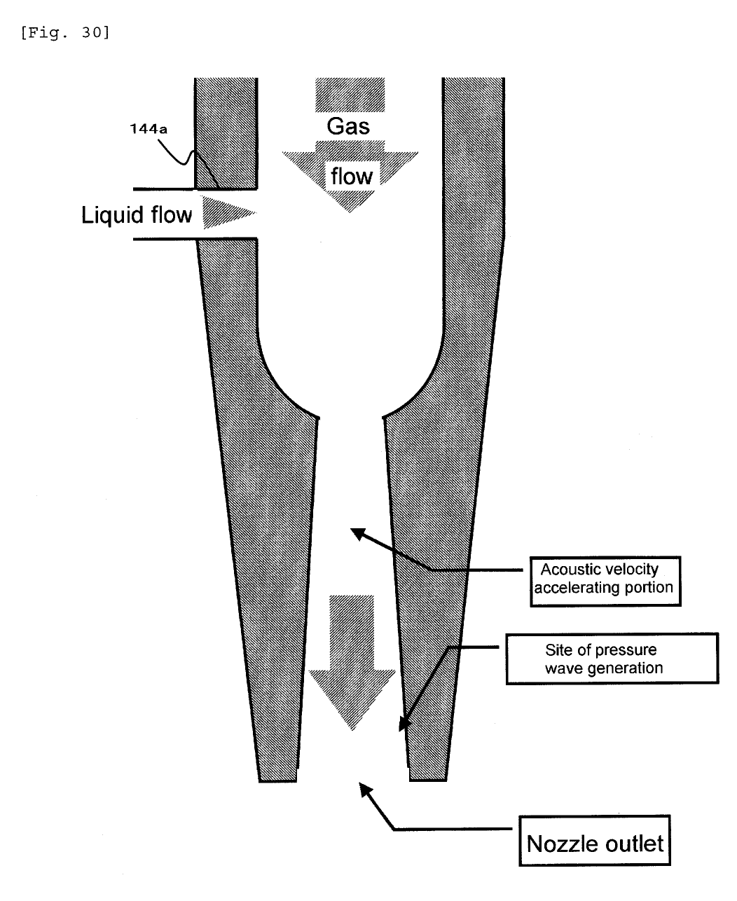

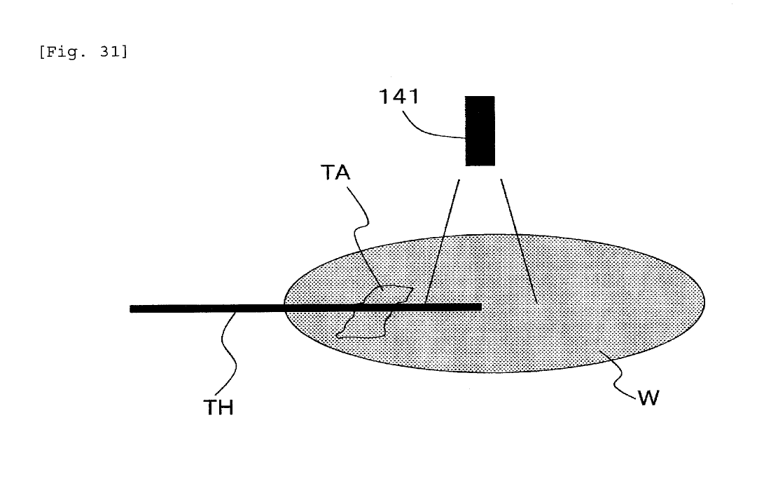

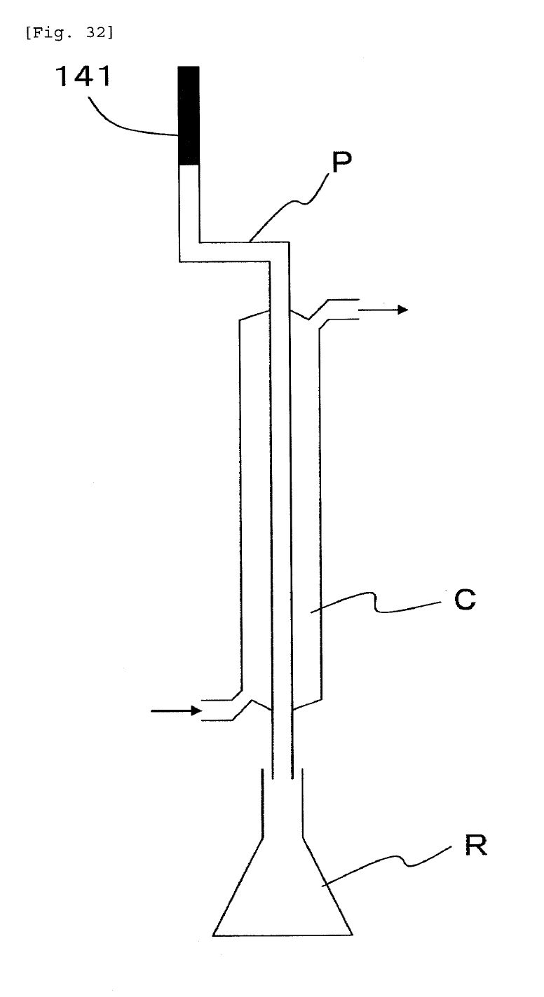

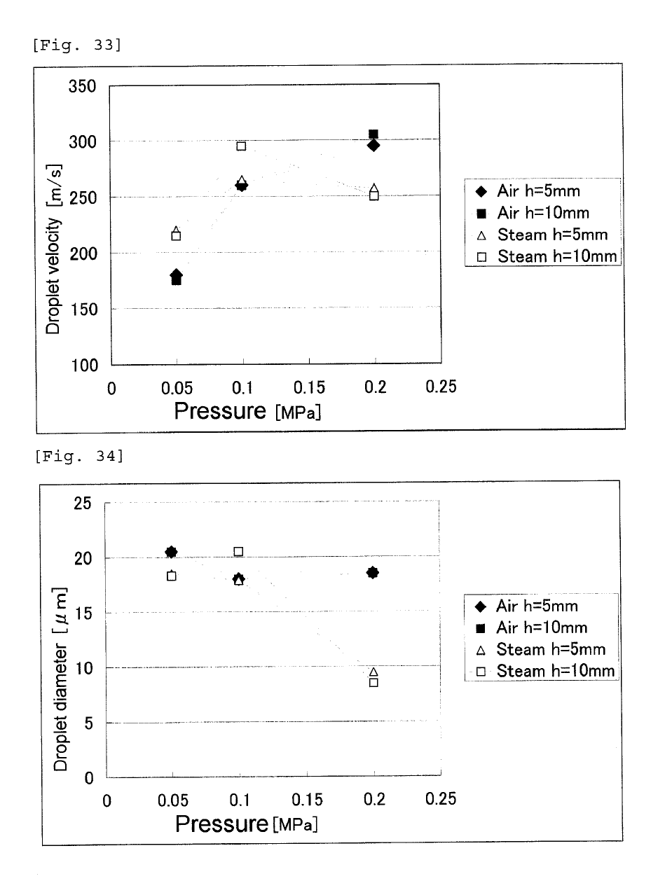

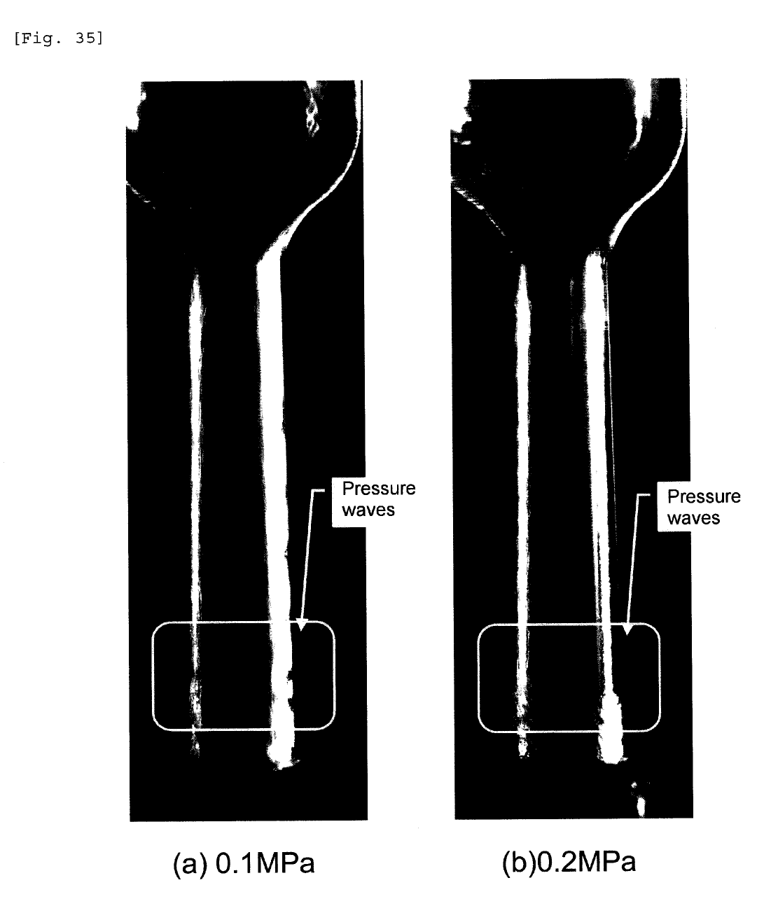

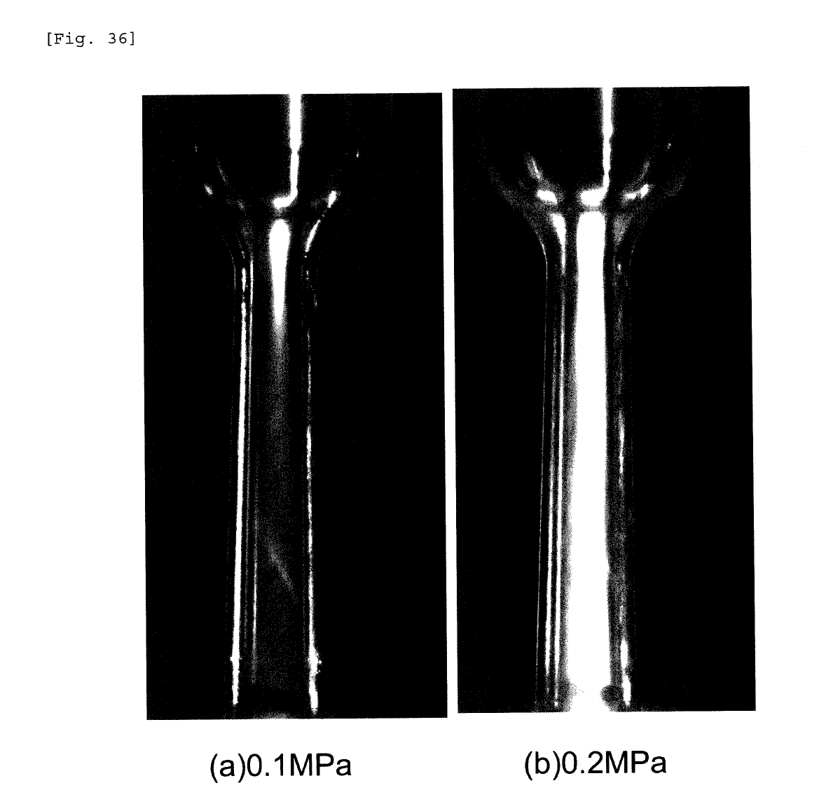

### DESIGNATION OF REFERENCE NUMERALS

100: apparatus for treating objects

111: water supply pipe

112: steam generator

113: steam on/off valve

114: pressure gauge

115: steam pressure regulating valve

116: heated steam generator/saturated steam wetness regulator with temperature control mechanism

117: pressure release valve

121: water supply pipe

122: heating portion with pure water temperature control mechanism

123: pure water on/off valve

124: pure water flowmeter

125: pure water on/off valve for producing two fluids

131: heating portion with steam fluid temperature control mechanism

141: injection nozzle

142: flexible piping

143: pressure gauge

144: multiphase fluid gas-liquid mixing portion with temperature control function

145: orifice

151: stage capable of carrying and holding

152: rotating motor

153: mechanism for elevating/lowering wafers

154: cooling water pipe

155: cooling water on/off valve

156: cooling water flow rate regulating valve

157: cooling water flowmeter

1. A method for cleaning an object, comprising a step of injecting through a nozzle a multiphase fluid, containing steam in a continuous phase and water droplets in a dispersed phase, which is produced by mixing steam and water at a mixing portion, wherein
the mixing portion is disposed at the upstream side of the nozzle and has a water inlet portion through part of its inner wall surface;
the nozzle is an ultrahigh-velocity nozzle;
the inner wall surface of the mixing portion and an inner wall surface of the nozzle form an approximately continuous, curved surface; and
the steam flowing within the mixing portion is mixed with the water from the inner wall surface of the mixing portion so that the water is passed from the inner wall surface of the mixing portion along the inner wall surface of the nozzle to inject the multiphase fluid through an outlet of the nozzle.

2. The method according to claim 1, wherein the nozzle has a divergent configuration in which the nozzle is reduced in diameter gradually from the upstream side of the nozzle to the outlet of the nozzle and is also increased in diameter across a throat portion where it has a minimum cross-sectional area.

3. The method according to claim 1, wherein the mixing portion is cylindrical.

4. The method according to claim 1, wherein the velocity of the droplets is in the range of 100 to 600 m/s.

5. The method according to claim 1, wherein the temperature of the multiphase fluid upon reaching the object is 50° C. or higher and the pH of the multiphase fluid upon reaching the object is in the range of 7 to 9.

6. The method according to claim 5, wherein the distance between a blowout outlet of the multiphase fluid and the object is 30 mm or less.

7. The method according to claim 1, wherein the object is a semiconductor substrate having an aluminum material on the surface.

8. A system for cleaning an object by injecting through a nozzle a multiphase fluid, containing steam and water droplets, comprising a steam supply means for supplying steam, water supply means for supplying liquid water and a nozzle for injecting a multiphase fluid, wherein
the mixing portion is disposed at the upstream side of the nozzle and has a water inlet portion through part of its inner wall surface, through which the flowing steam may be mixed with the water from the inner wall surface;
the nozzle is an ultrahigh-velocity nozzle; and
the inner wall surface of the mixing portion and an inner wall surface of the nozzle form an approximately continuous, curved surface.

9. The system according to claim 8, wherein the nozzle has a divergent configuration in which the nozzle is reduced in diameter gradually from the upstream side of the nozzle to the outlet of the nozzle and is also increased in diameter across a throat portion where it has a minimum cross-sectional area.

10. The system according to claim 8, wherein the mixing portion is cylindrical.

11. The method according to claim 2, wherein the mixing portion is cylindrical.

12. The method according to claim 2, wherein the velocity of the droplets is in the range of 100 to 600 m/s.

13. The method according to claim 3, wherein the velocity of the droplets is in the range of 100 to 600 m/s.

14. The method according to claim 2, wherein the temperature of the multiphase fluid upon reaching the object is 50° C. or higher and the pH of the multiphase fluid upon reaching the object is in the range of 7 to 9.

15. The method according to claim 3, wherein the temperature of the multiphase fluid upon reaching the object is 50° C. or higher and the pH of the multiphase fluid upon reaching the object is in the range of 7 to 9.

16. The method according to claim 4, wherein the temperature of the multiphase fluid upon reaching the object is 50° C. or higher and the pH of the multiphase fluid upon reaching the object is in the range of 7 to 9.

17. The method according to claim 2, wherein the object is a semiconductor substrate having an aluminum material on the surface.

18. The method according to claim 3, wherein the object is a semiconductor substrate having an aluminum material on the surface.

19. The method according to claim 4, wherein the object is a semiconductor substrate having an aluminum material on the surface.

20. The system according to claim 9, wherein the mixing portion is cylindrical.
